(19) United States
(12) Patent Application Publication
(10) Pub. No.: US 2013/0109005 A1
(43) Pub. Date: May 2, 2013

(54) HUMAN MODEL

(71) Applicants: Christopher T. HARDY, Springfield, IL (US); Keying Zhang, Hangzhou (CN); Jian Hua Xu, Xiao Shan (CN)

(72) Inventors: Christopher T. HARDY, Springfield, IL (US); Keying Zhang, Hangzhou (CN); Jian Hua Xu, Xiao Shan (CN)

(73) Assignee: Design Ideas, Ltd., Springfield, IL (US)

(21) Appl. No.: 13/473,073

(22) Filed: May 16, 2012

Related U.S. Application Data
(63) Continuation-in-part of application No. 13/286,866, filed on Nov. 1, 2011.

(30) Foreign Application Priority Data
Dec. 28, 2011 (CN) 201110461199.4

(51) Int. Cl. G09B 25/00; F16C 11/04

(52) U.S. Cl. 434/365; 403/53

(57) ABSTRACT

This invention is directed to model human figures. More particularly, this invention is directed to a model human figure comprising a frame with joints. This invention is also directed to a model human figure comprising a frame and a wire body with joints.

### CROSS-REFERENCE TO RELATED APPLICATIONS

This application is a continuation-in-part of pending U.S. application Ser. No. 13/286,866, filed Nov. 1, 2011, and claims priority to pending U.S. application Ser. No. 29/410,486, filed Jan. 9, 2012 and pending Chinese Application No. 201110461199.4, filed Dec. 28, 2011, all of which are herein incorporated by reference.

### FIELD OF THE INVENTION

The invention is directed to model human figures. More particularly, the invention is directed to a model human figure comprising a frame and joints. The invention is also directed to a model human figure comprising a frame and a wire body with joints.

### BACKGROUND OF THE INVENTION

Models are widely available in an assortment of shapes, styles, and colors to represent full scale objects and/or living creatures. Human models are often used by artists and art students to draw the human form in a variety of poses. Models may also be used as toys, decorations, desk accessories, and other purposes. Many of the models available today, however, have limitations. For example, many of the available models are not capable of being posed in a standing position without the aid of a pedestal or a support rod. Many models have only limited or unidirectional movement of limbs, limiting the variety of poses they can achieve and reducing the life-likeness of those poses.

Art students often use human models to practice drawing the basic human shape. A commonly used artist model is made of wooden pieces representing human body segments and is held together by an internal wire. Such a model, however, is often unable to stand on its own and therefore must be supported by a rod or the feet must be affixed to a base in order to achieve a standing position. This may prevent the model from achieving a variety of positions, such as a sitting position, and may require the inclusion of a foreign element in the model. The wooden segments are solid and opaque, preventing the artist from seeing the opposite side and from viewing the three-dimensional shape of the model. The wooden models also have simple wooden hands that are incapable of holding items. The wooden models have joints that contain springs, making it difficult for the model to remain in a given pose without springing back to a neutral position.

Thus, there is a need in the art for a model with movable segments, that can stand or be arranged in a variety of positions, including a standing and sitting position, that enables the viewer to see through the model to the opposite side, and that has joints allowing for at least a four-way range of motion and enabling the model to stay in a posed position.

### BRIEF SUMMARY OF THE INVENTION

The invention relates to human models with an internal frame and joints to enable movement. The invention also relates to human models with an internal frame, a wire external frame, and joints to enable movement. The model may also include hands capable of holding objects.

### BRIEF DESCRIPTION OF THE DRAWINGS

In the accompanying drawings that form a part of the specification and are to be read in conjunction therewith, the present invention is illustrated by way of example and not limitation, with like reference numerals referring to like elements, wherein:

FIGS. 1A-1C illustrate first examples of a model of the present invention.

FIGS. 2A-2E illustrate second examples of a model of the present invention.

FIG. 3 illustrates an example of the external frame of the model of FIG. 2A.

FIG. 4A illustrates an example of a two-way open joint of the present invention.

FIG. 4B illustrates an exploded view of the two-way open joint of FIG. 4A.

FIG. 4C illustrates an example of a three-way open joint of the present invention.

FIG. 4Ci illustrates another example of a three-way open joint of the present invention.

FIG. 4Cii illustrates another example of a three-way open joint of the present invention.

FIG. 4D illustrates an exploded view of the three-way open joint of FIG. 4C.

FIG. 4Di illustrates an exploded view of a three-way open joint with conical shaped spacers.

FIG. 4Dii illustrates an exploded view of the three-way open joint with wave shaped conical spacers.

FIG. 4E illustrates an example of a two-way closed joint of the present invention.

FIG. 4F illustrates an exploded view of the two-way closed joint of FIG. 4E.

FIGS. 5A-5D illustrate the movement of the two-way open joint of FIGS. 4A and 4B.

FIGS. 5E-5J illustrate the movement of the three-way open joint of FIGS. 4C and 4D.

FIGS. 5K-5N illustrate the movement of the two-way closed joint of FIGS. 4E-4F.

FIGS. 6A-6M illustrates the model of FIGS. 1 and 2 in a variety of poses.

FIGS. 7A-7E(iv) illustrate examples of configurations of internal frame hand segments.

### DETAILED DESCRIPTION OF THE INVENTION

The invention relates to a human model with an internal frame and joints that allow the model to be posed in a variety of life-like positions including an unaided standing position. The model may also contain a wire external frame. The model may also contain hands capable of holding objects.

As used herein, the terms below are given the definitions that follow. The definitions are supplied to provide clarity and consistency and are not intended in any way to limit the scope of the invention.

Model or Human Model: an inanimate object used to represent the human form.

Internal Frame: a structural portion of a model that provides support for the model.

External Frame, External Wire Frame, or Wire Frame: a portion of a model made of wire that represents the outside of a body and is supported by the internal frame.

Joint: a mechanism which joins together two body segments.

Two-way Joint: a joint capable of moving along two axes (for example, an X axis and a Y axis).

Three-way Joint: a joint capable of moving along three axes (for example, an X-axis, a Y axis, and a Z axis).

Closed Joint: a joint comprised of a solid core supporting the hinges.

Open Joint: a joint comprised of an open core supporting the hinges.

Square Bracket: a material formed in a generally square shape serving as the support for the hinges in an open joint.

Horseshoe bracket: a material formed in a generally U or horseshoe shape serving as part of three-way joint.

The model of the present invention includes an internal frame and several joints that mimic human joints. A wire external frame may be disposed around internal frame. Model is capable of standing on its own as well as being posed in a variety of other configurations such as sitting, kneeling, lying down, etc. Model may also contain hands capable of holding objects.

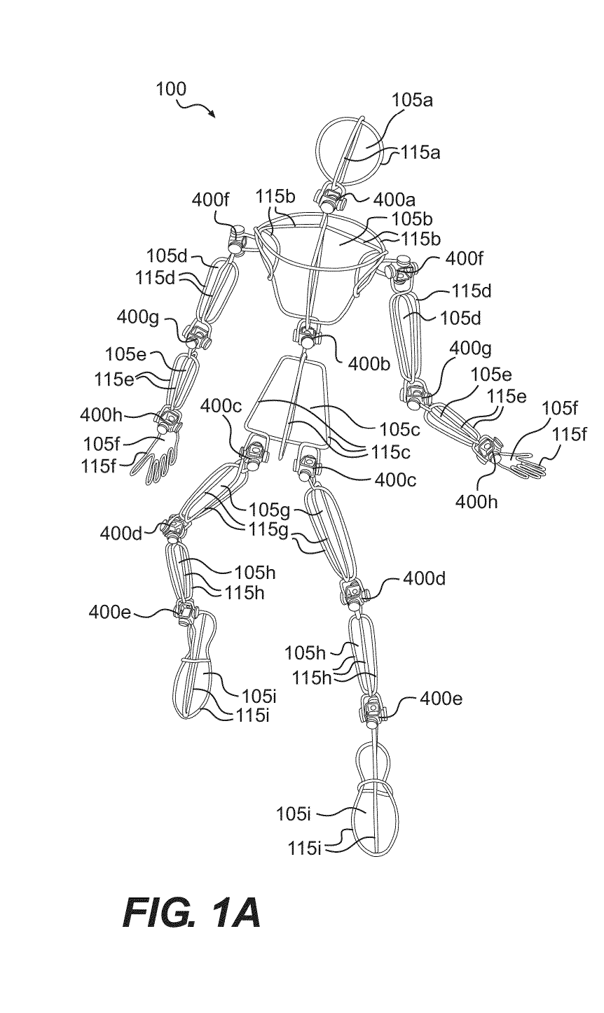

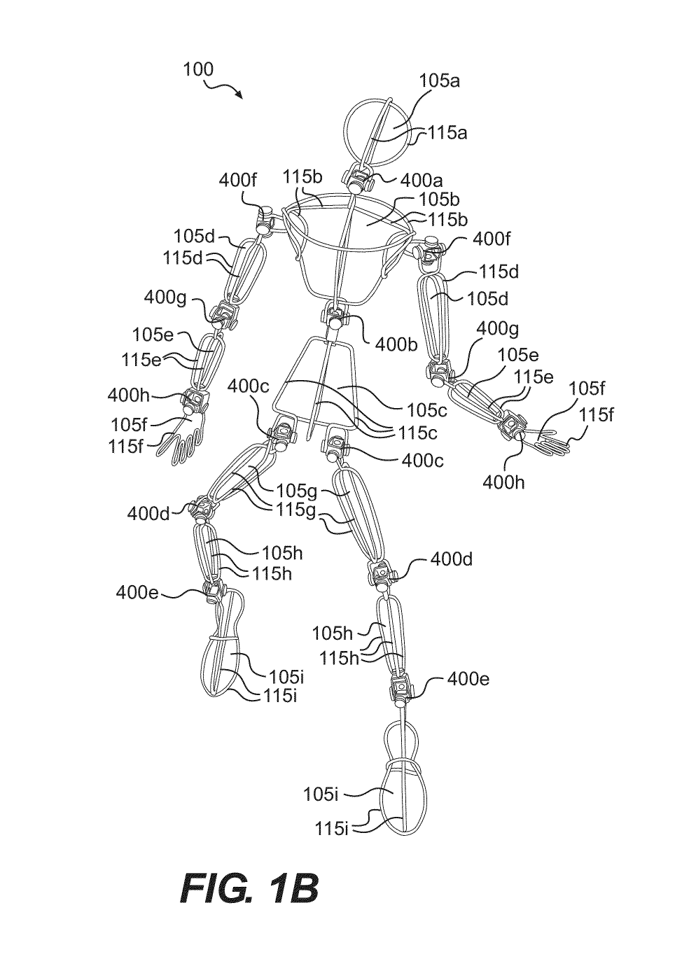

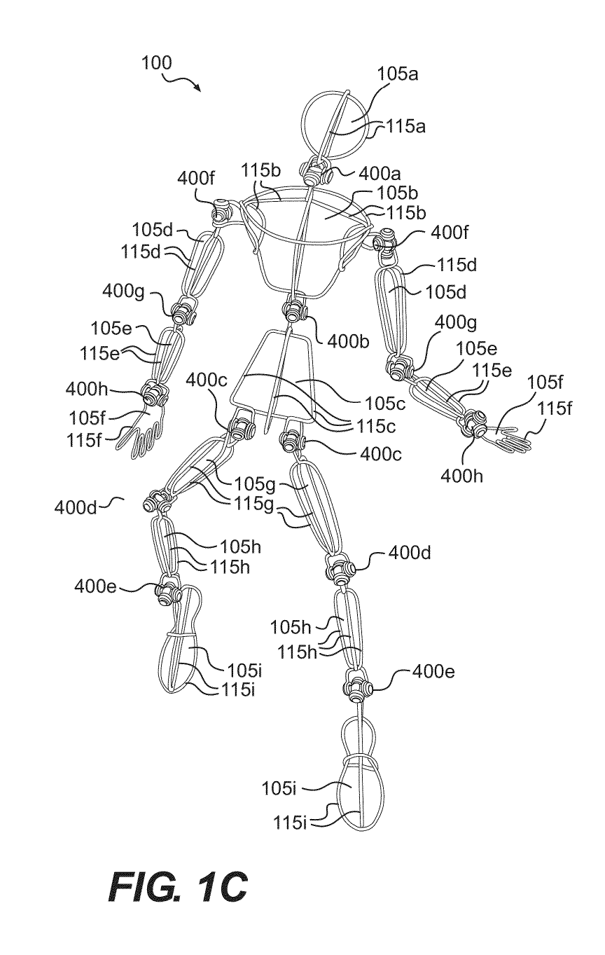

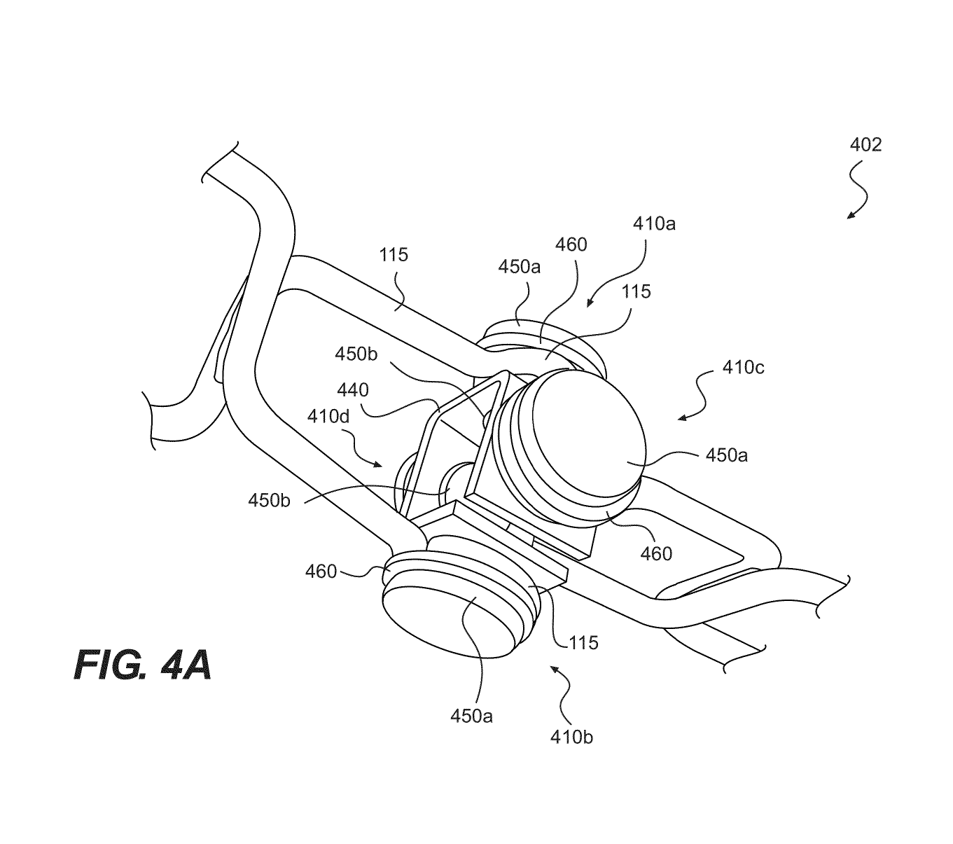

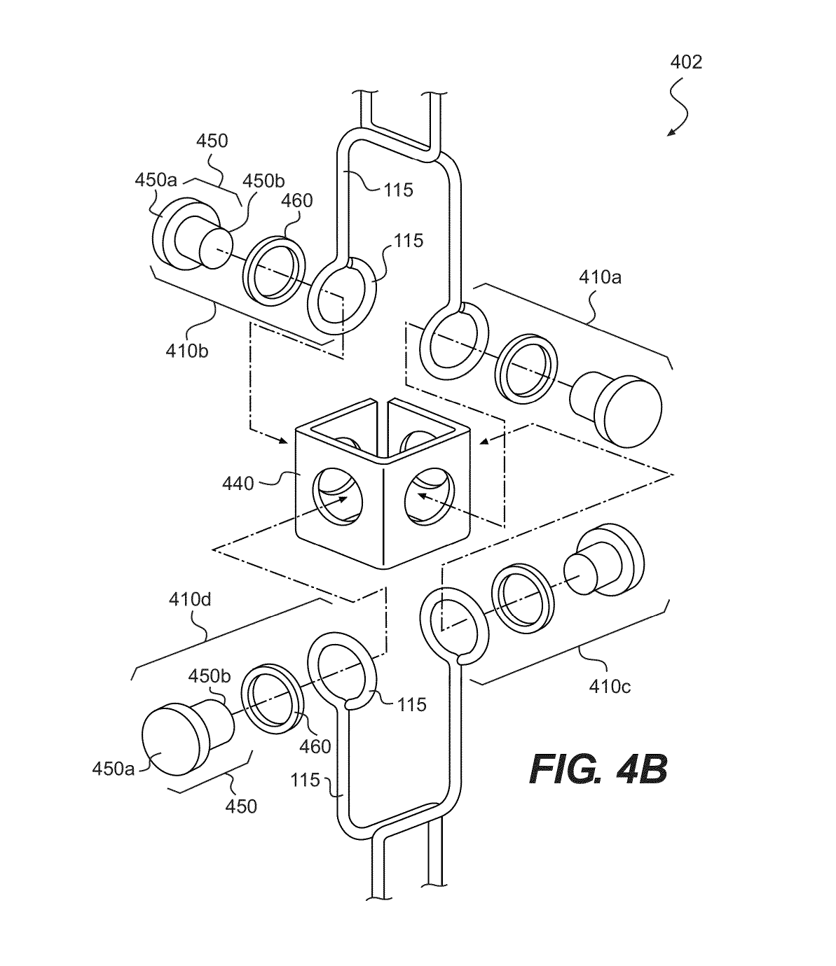

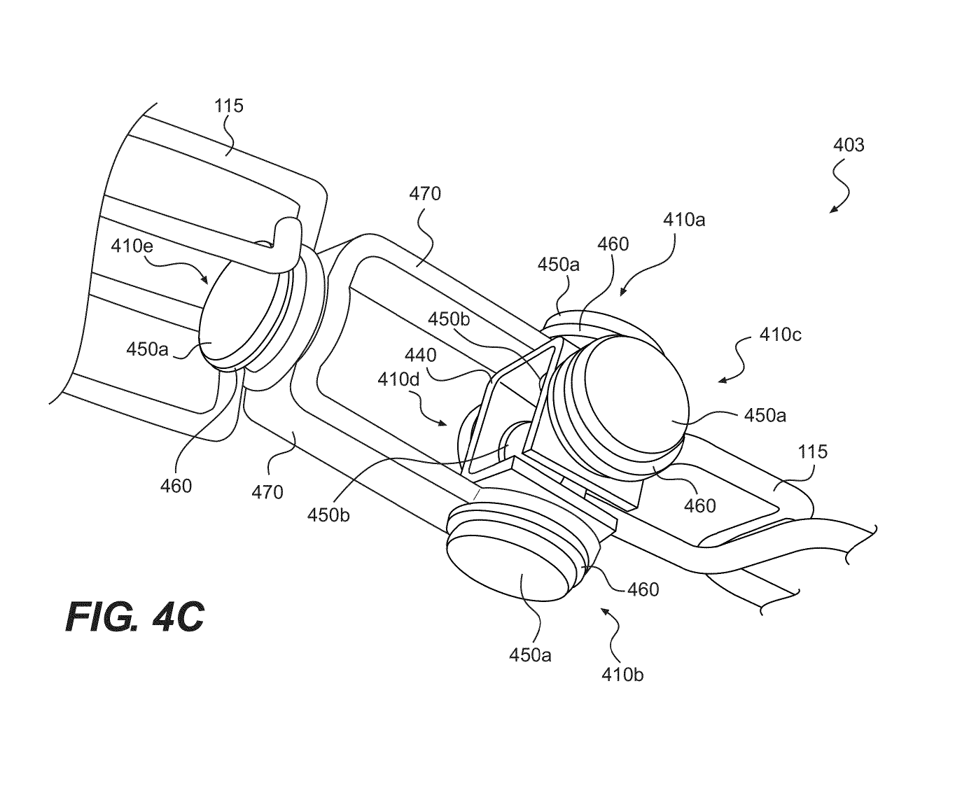

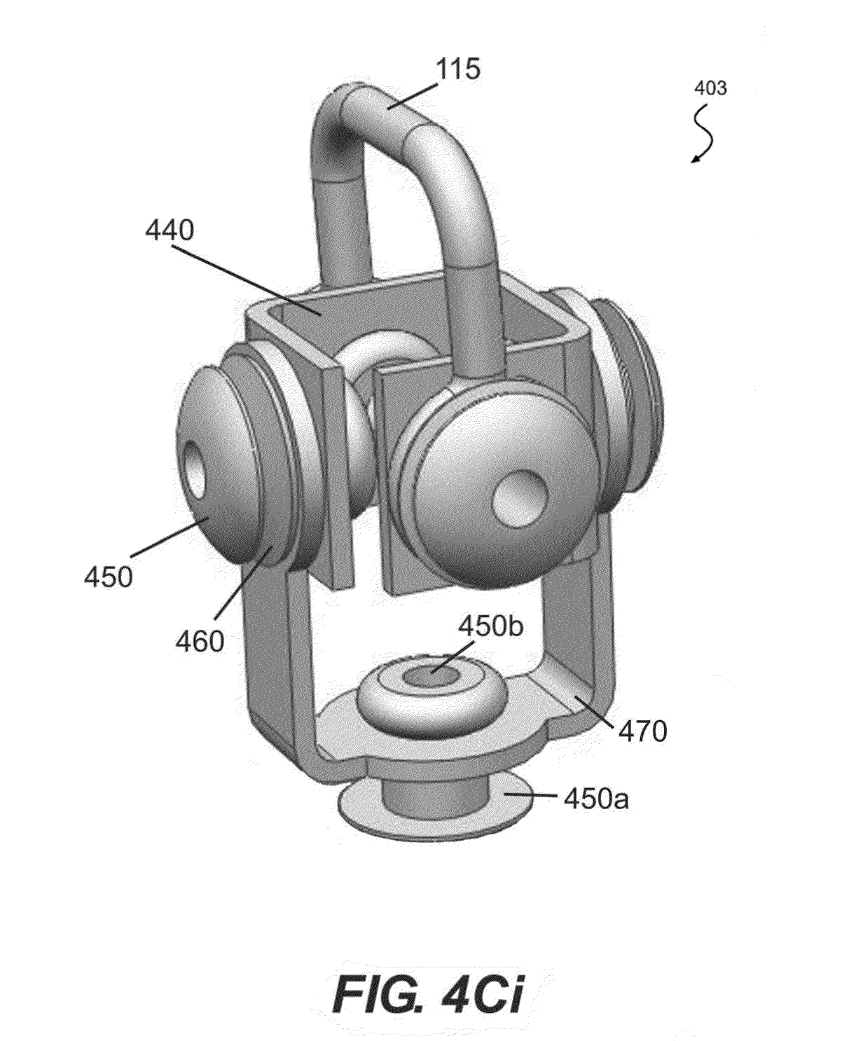

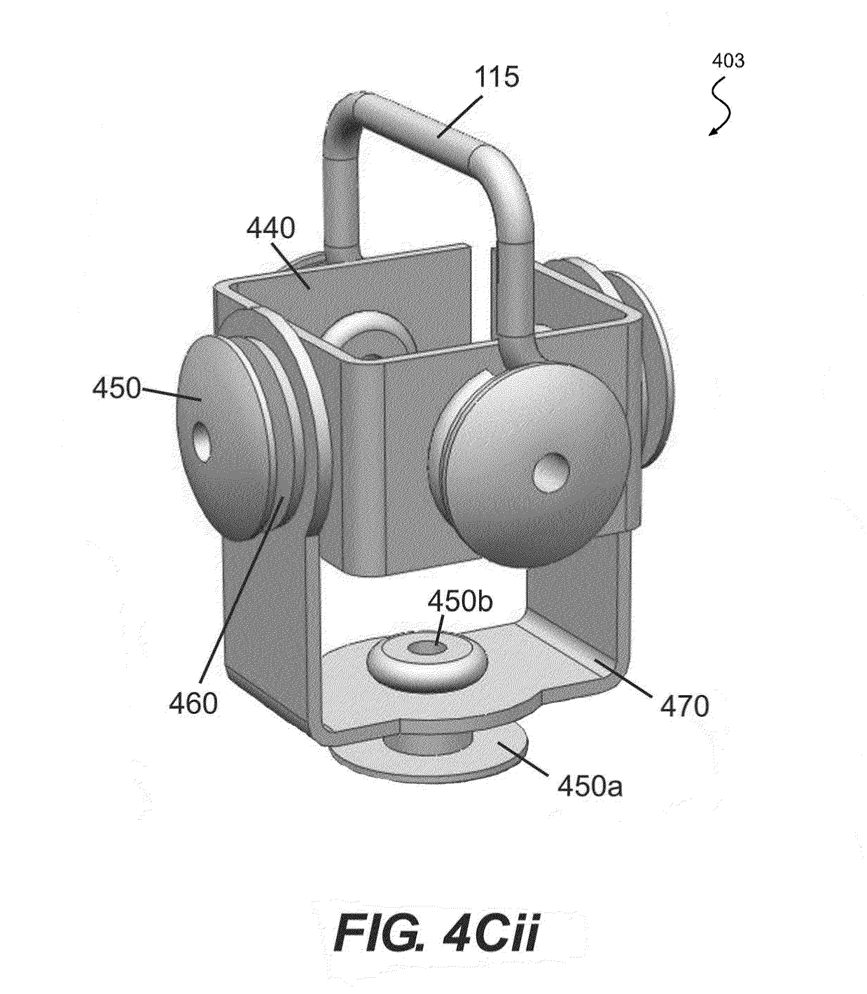

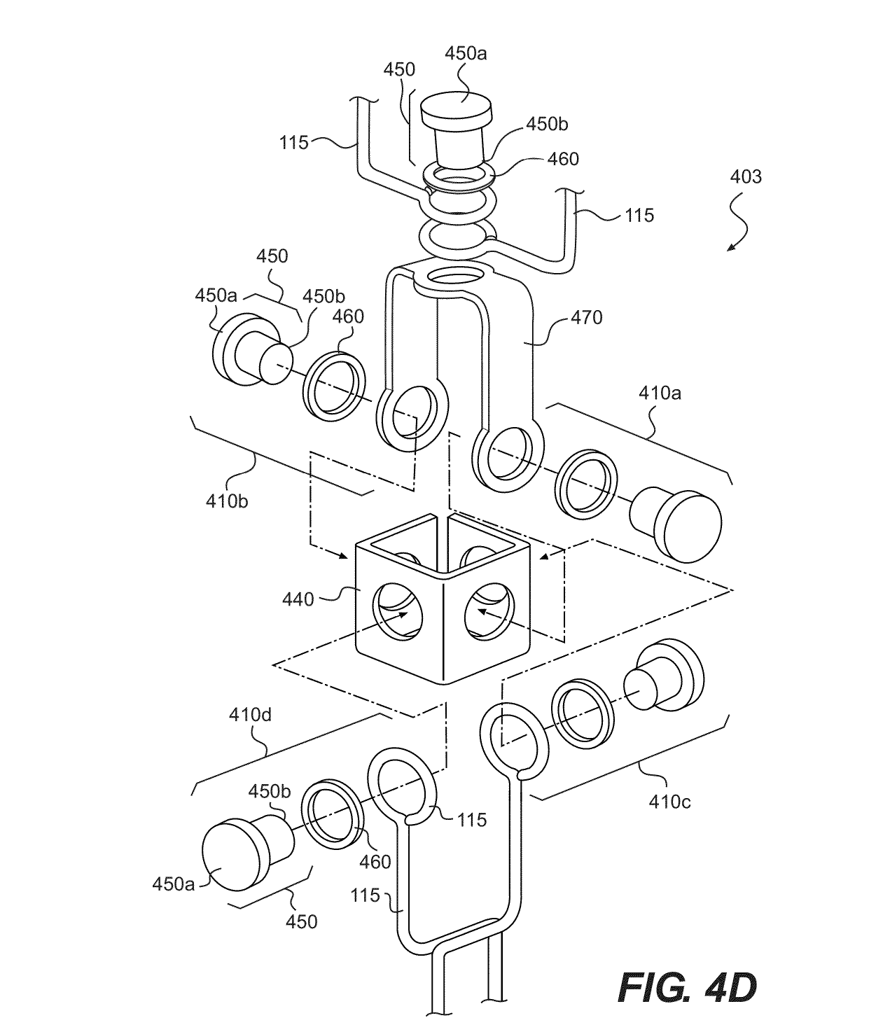

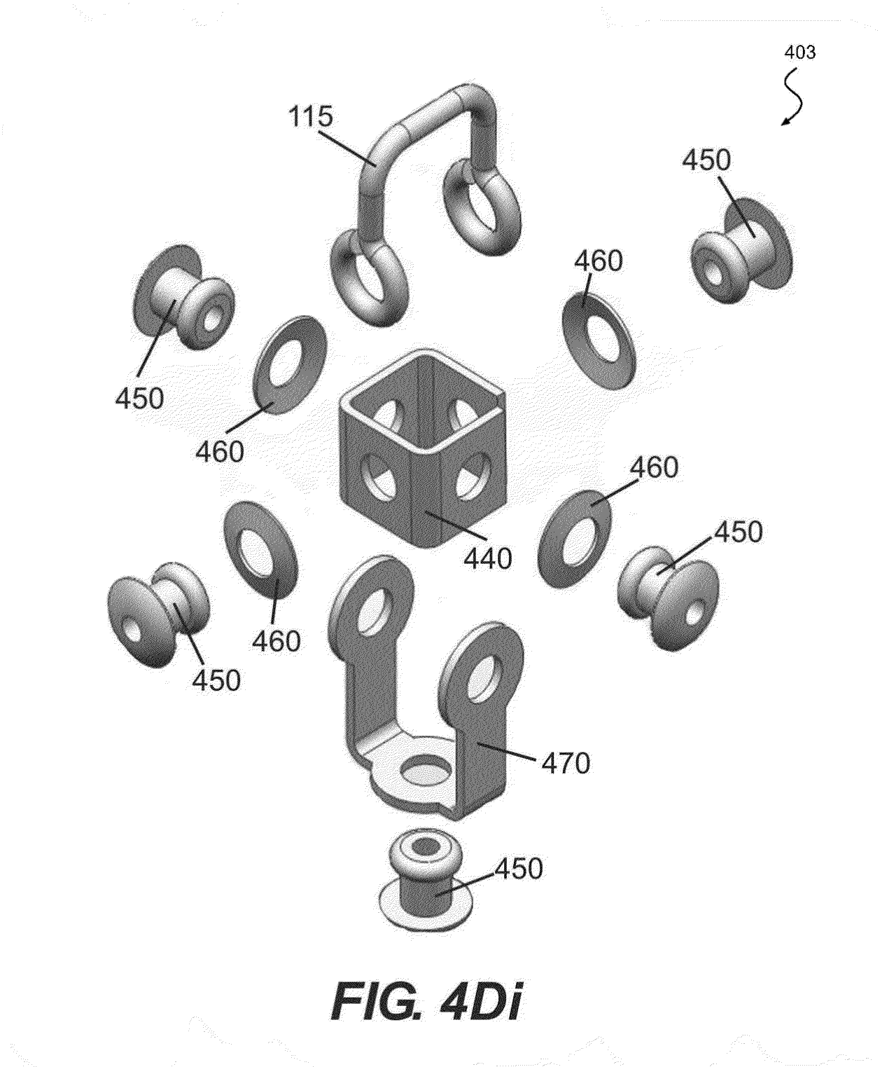

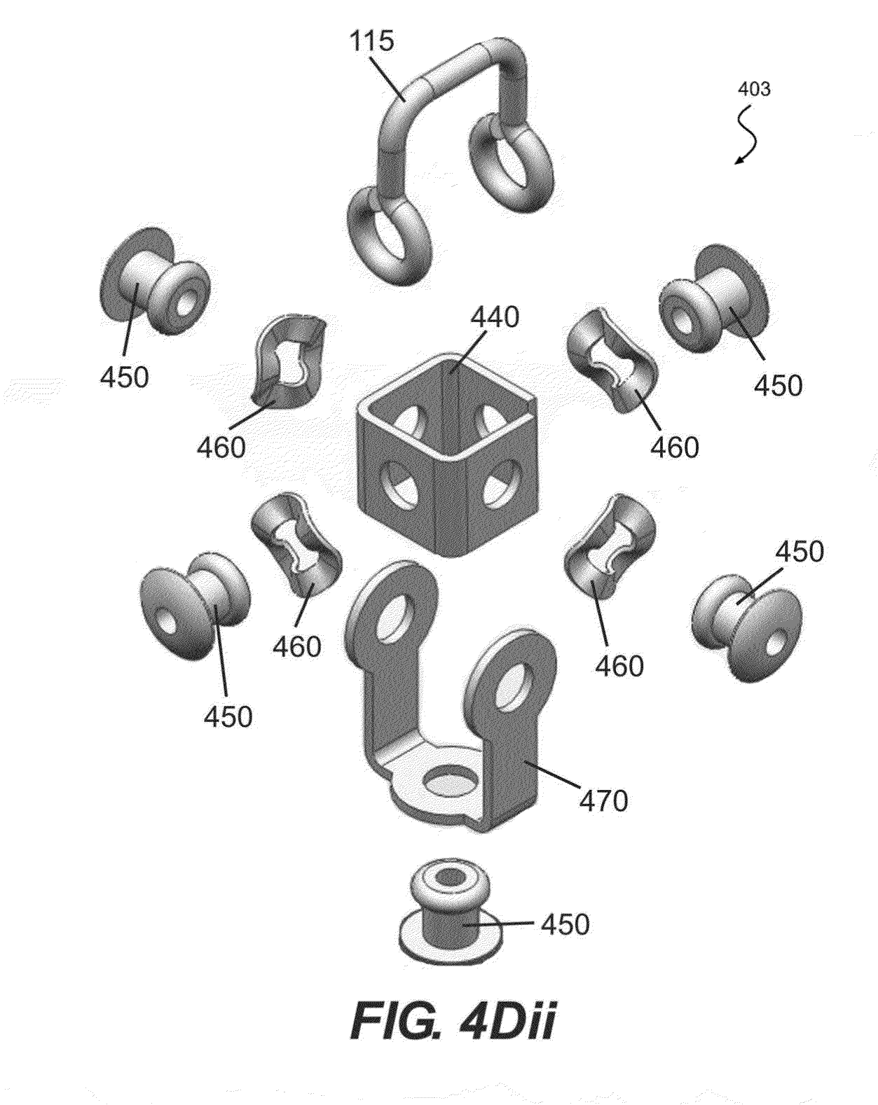

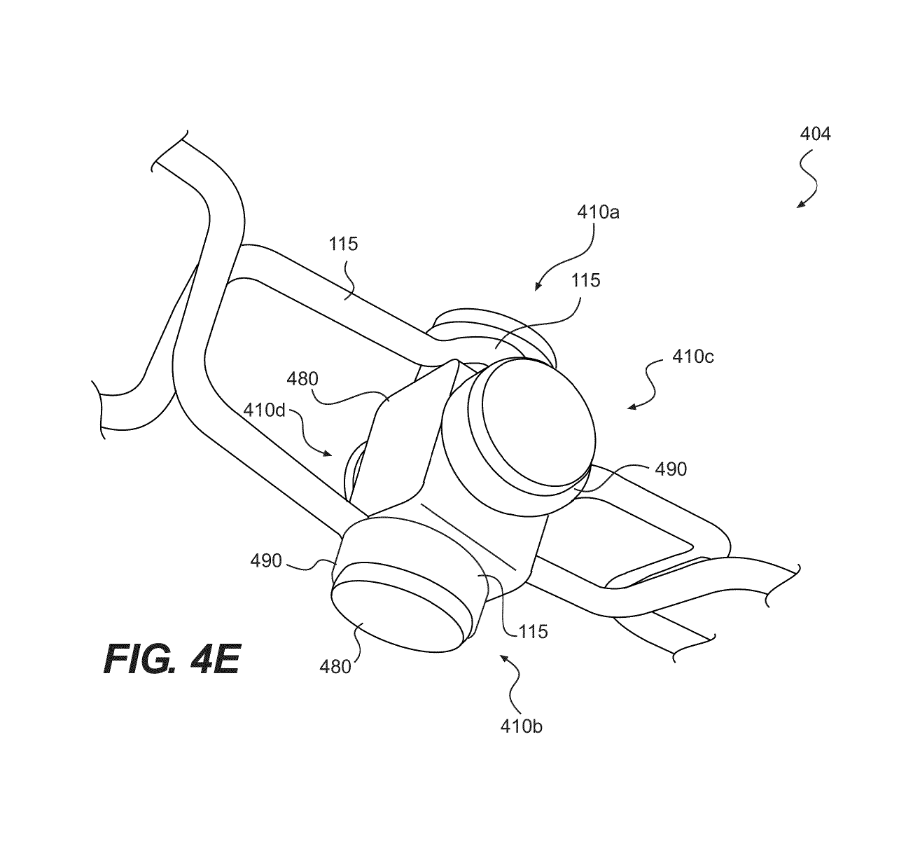

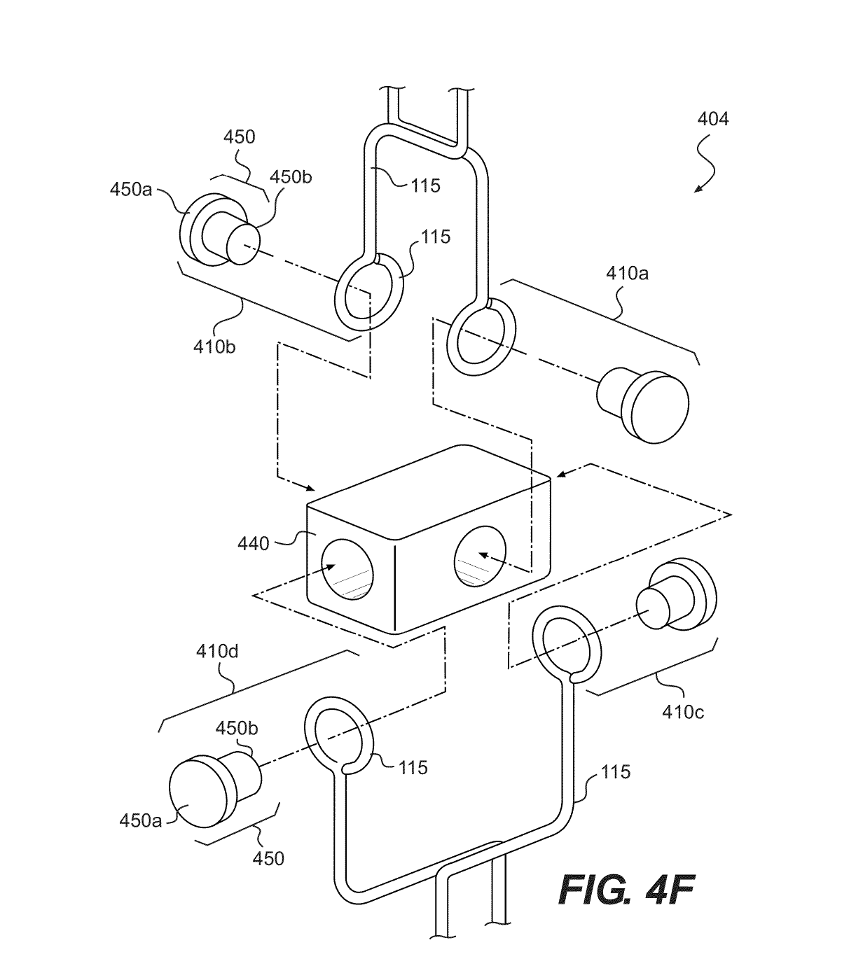

FIGS. 1A-1C illustrate examples of a first model 100 of the present invention. FIG. 1A illustrates a first model 100 with all two-way open joints (described in FIGS. 4A and 4B). FIG. 1B illustrates a first model 100 with a combination of two-way open joints and three-way open joints (described in FIGS. 4C and 4D). FIG. 1C illustrates a first model 100 with all two-way closed joints (described in FIGS. 4E and 4F). FIG. 1 illustrates a front view of model 100. First model 100 can be any size provided the proportions are recognizable as human.

First model 100 generally comprises several body segments 105 representing human body segments. For example, first model 100 includes one head segment 105a, one chest segment 105b, one pelvis segment 105c, two upper arm segments 105d, two forearm segments 105e, two hand segments 105f, two upper leg segments 105g, two lower leg segments 105h, and two foot segments 105i.

As shown in FIGS. 1A-1C, first model 100 includes an internal frame 115. Internal frame 115 provides structure to first model 100. Internal frame 115 is divided into several internal frame body segments 115a-115i that correspond to each of the body segments 105a-105i. For example, head segment 105a contains an internal frame head segment 115a; chest segment 105b contains an internal frame chest segment 115b; pelvis segment 105c contains an internal frame pelvis segment 115c; each upper arm segment 105d contains an internal frame upper arm segment 115d; each forearm segment 105e contains an internal frame forearm segment 115e; each hand segment 105f contains an internal frame hand segment 115f; each upper leg segment 105g contains an internal frame upper leg segment 115g; each lower leg segment 105h contains an internal frame lower leg segment 115h; and each foot segment 105i contains an internal frame foot segment 115i.

Each internal frame body segment 115 is a support structure that acts as a “skeleton” and provides first model 100 with its basic shape. Unlike an actual human skeleton, however, internal frame 115 is not made of single bones in the center of the body part it is supporting. Instead, each internal frame segment 115 is molded in the general shape of the body part is it representing. For example, as can be seen in FIG. 1, internal frame foot segment 115i is molded in the general shape of a foot. Likewise, internal frame forearm segments 115e are molded in the general shape of forearms and internal frame head segment 115a is molded in the general shape of a head.

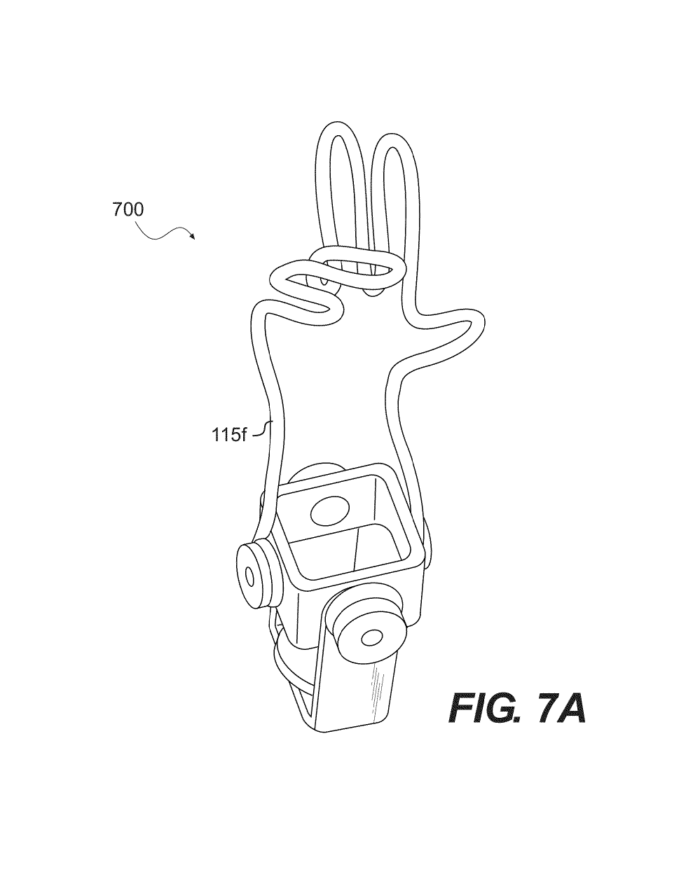

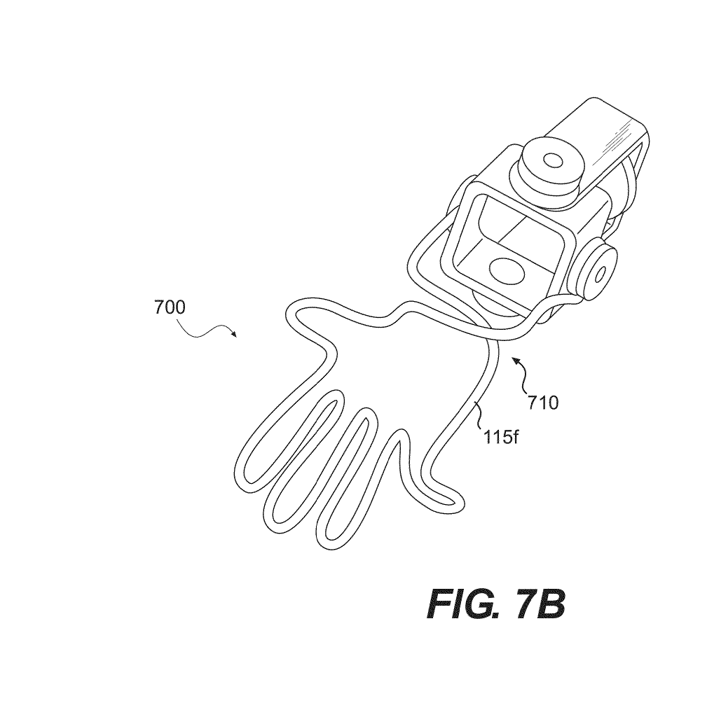

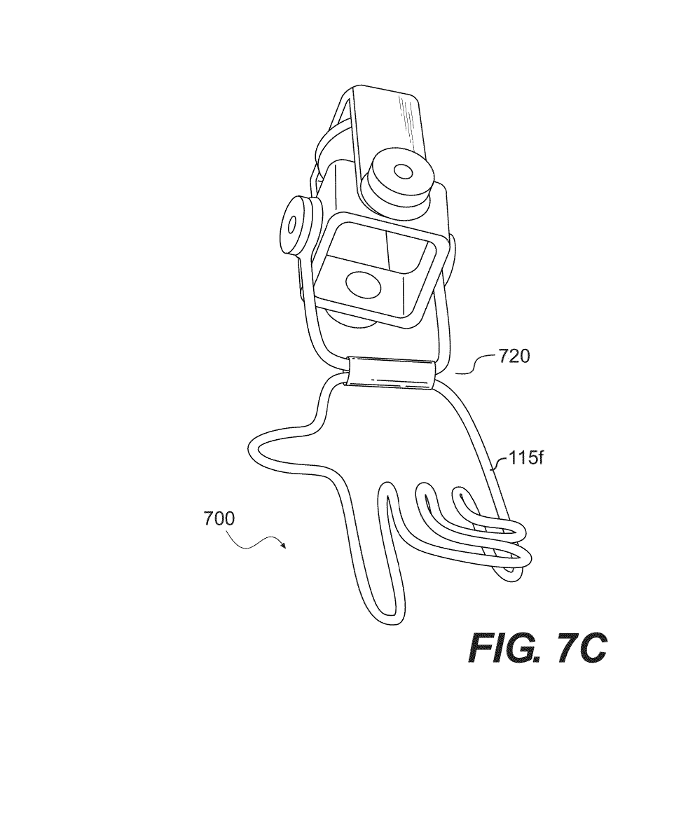

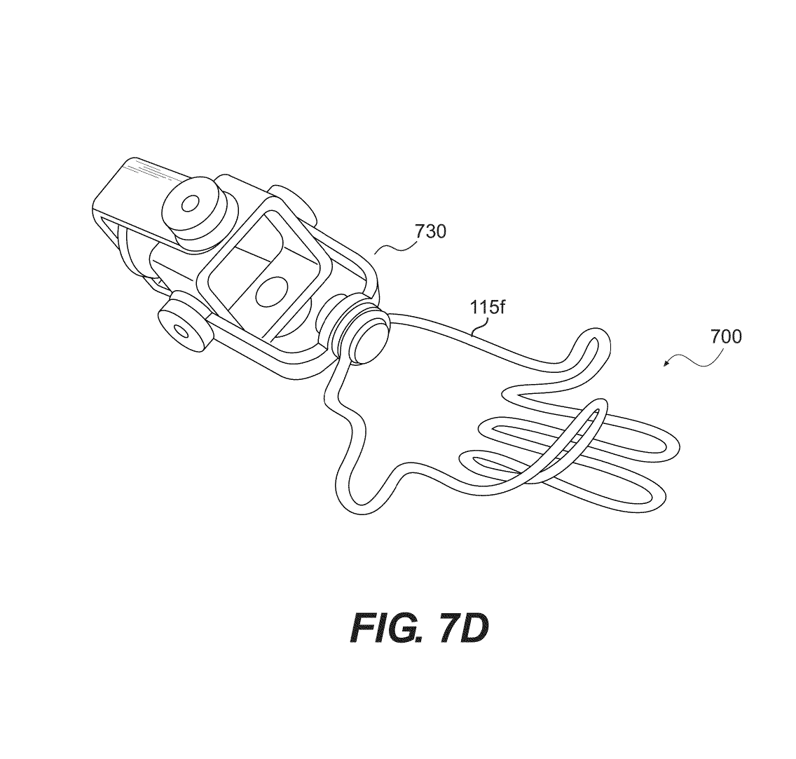

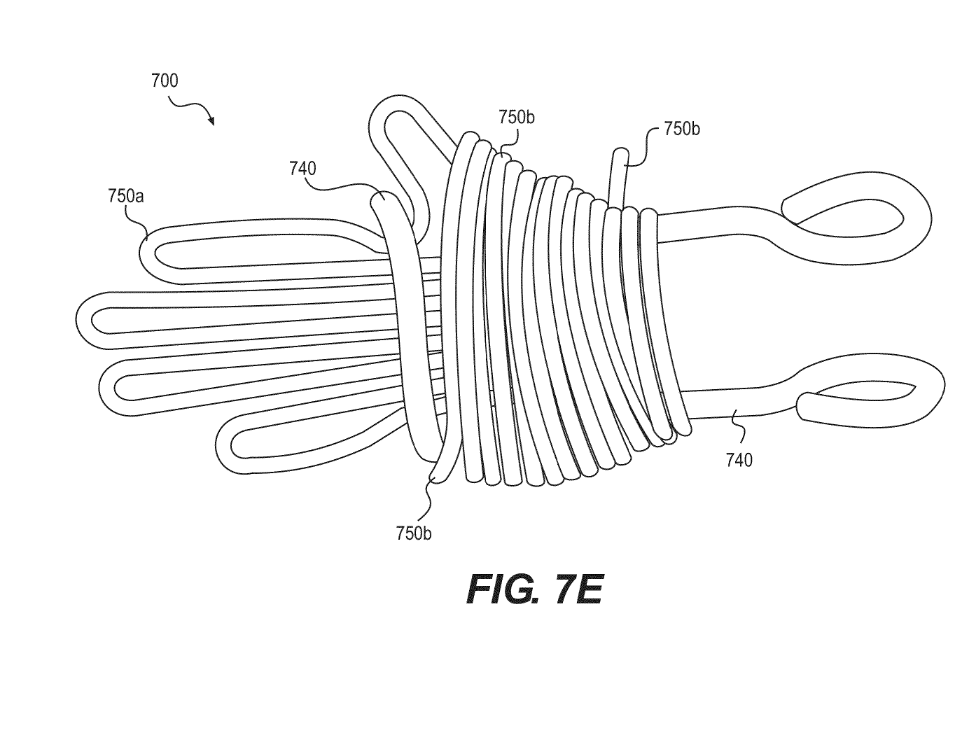

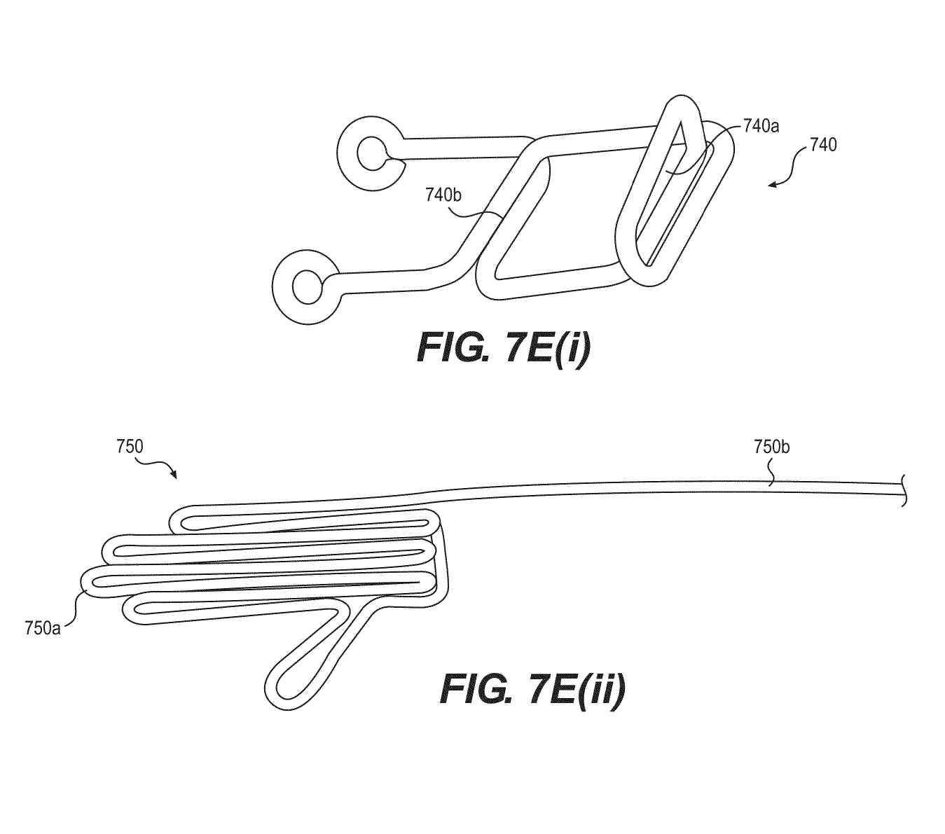

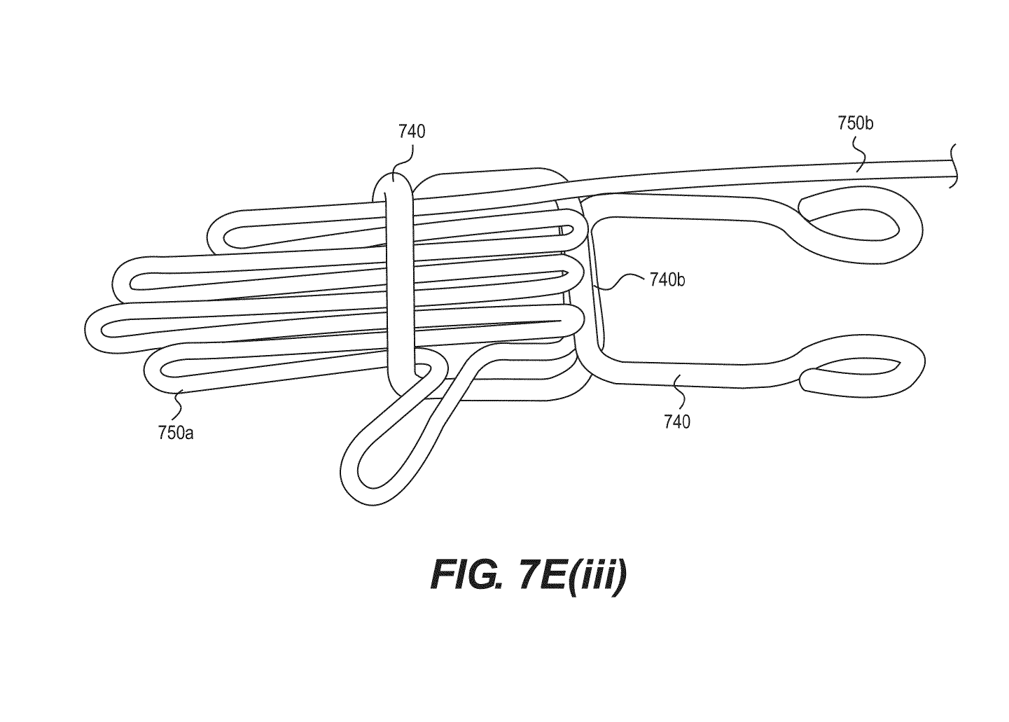

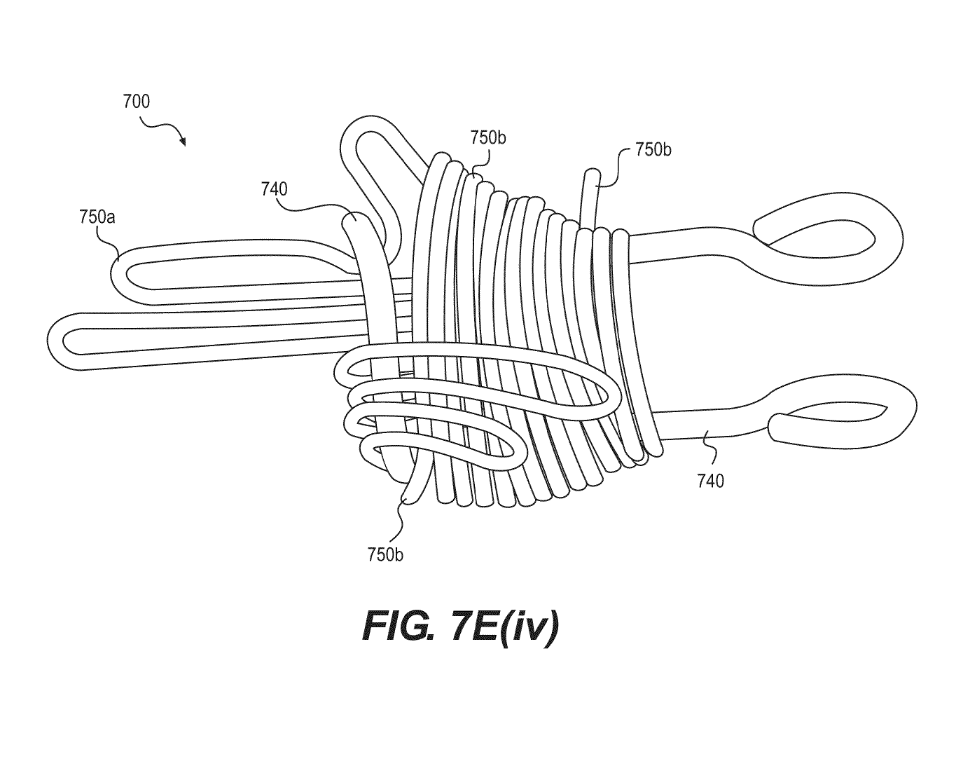

Internal frame foot segment 115i is configured so that the bottom of foot segment 105i is flat, enabling model 100 to stand on a flat surface with no additional support. Internal frame hand segment 115f may be molded to include the shape of fingers to enable hand segment 115f to hold small objects, such as paper, stamps, business cards, greeting cards, brochures, or any other suitable object. Additional configurations of internal frame hand segment 115f are described in FIGS. 7A-7D.

Internal frame 115 can be made of any material capable of supporting model 100. By way of example, internal frame 115 can be made of metal (such as, for example, stainless steel, iron, copper, aluminum, epoxy coated steel, vinyl coated steel, steel with an anodized finish), plastic, or any other suitable material. Internal frame 115 can retain the color of the underlying material or it can be changed to another color by painting, dying, coating, or any other means capable of changing the color.

Body segments 105 are connected by joints 400 (which are shown in more detail in FIGS. 4A-4F), including one neck joint 400a, one waist joint 400b, two hip joints 400c, two knee joints 400d, two ankle joints 400e, two shoulder joints 400f, two elbow joints 400g and two wrist joints 400h.

Specifically, neck joint 400a connects internal frame head segment 115a with internal frame chest segment 115b; waist joint 400b connects internal frame chest segment 115b with internal frame pelvis segment 115c; each hip joint 400c connects internal frame pelvis segment 115c with an internal frame upper leg segment 115g; each knee joint 400d connects an internal frame upper leg segment 115g with the corresponding internal frame lower leg segment 105h; each ankle joint 400e connects an internal frame lower leg segment 115h with a corresponding internal frame foot segment 115i; each shoulder joint 400f connects internal frame chest segment 115b with an internal frame upper arm segment 115d; each elbow joint 400g connects an internal frame upper arm segment 115d with a corresponding internal frame forearm segment 115e; and each wrist joint 400h connects an internal frame forearm segment 115e with the corresponding internal frame hand segment 115f. Joints 400 correspond to analogous human joints except that the “waist joint” 400b is a single joint that replaces the movement allowed by the vertebra in a living human.

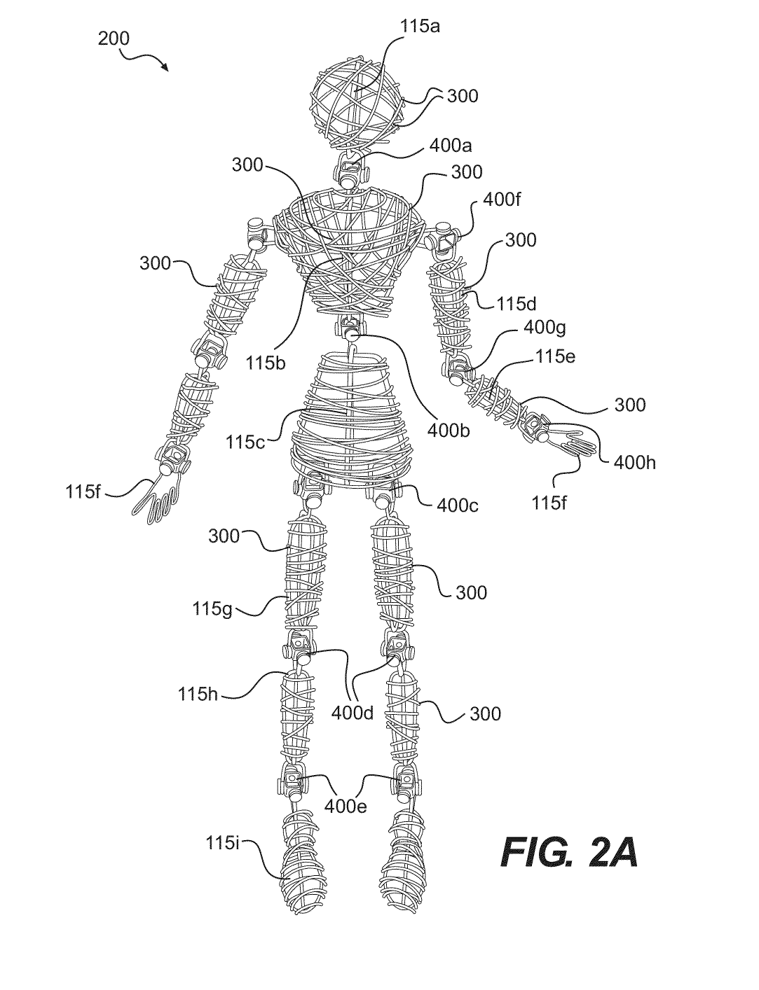

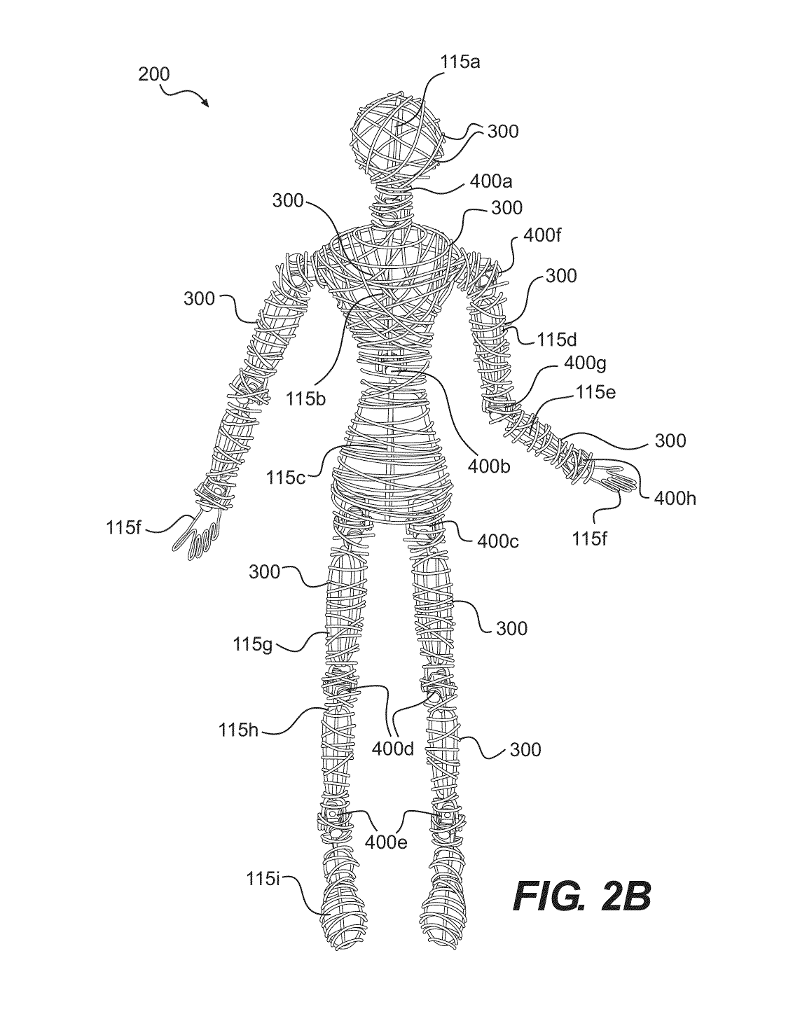

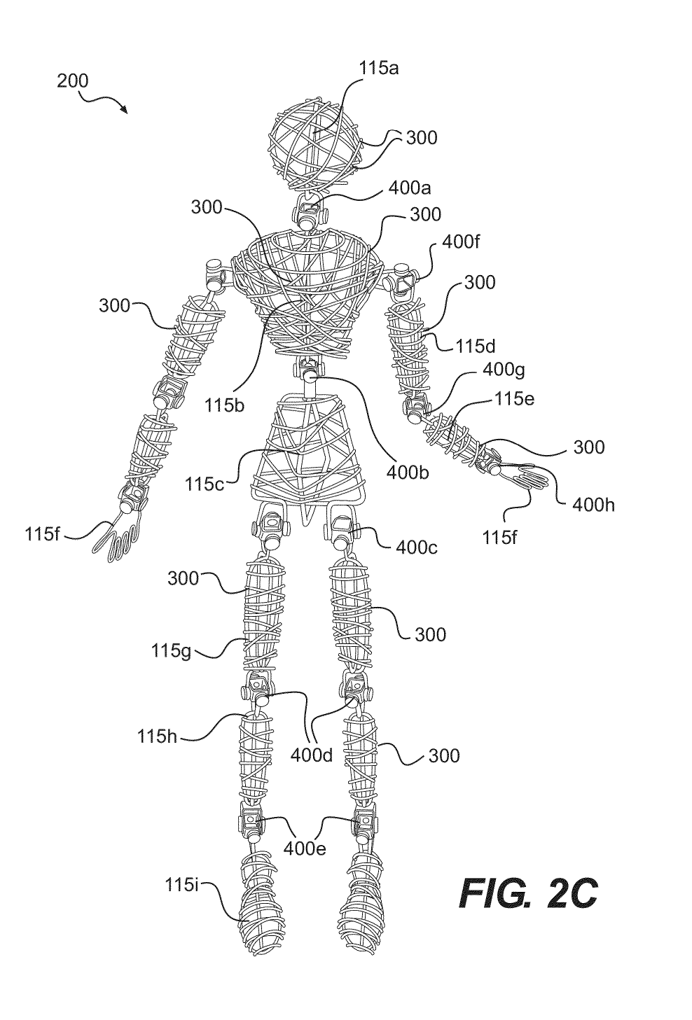

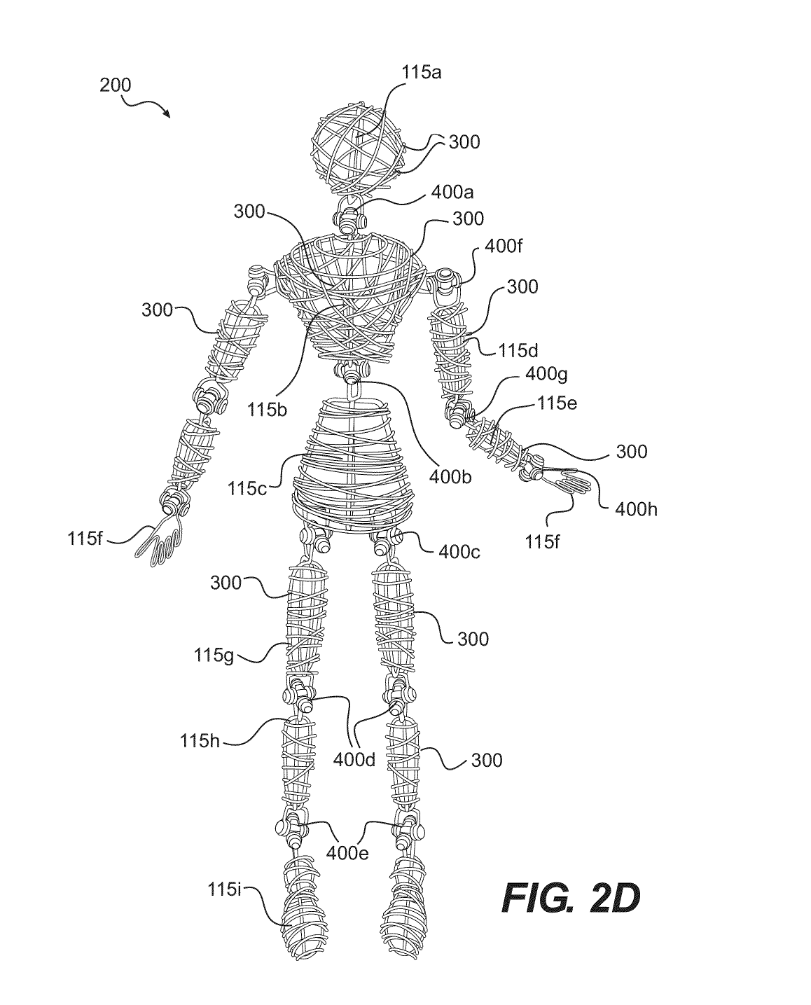

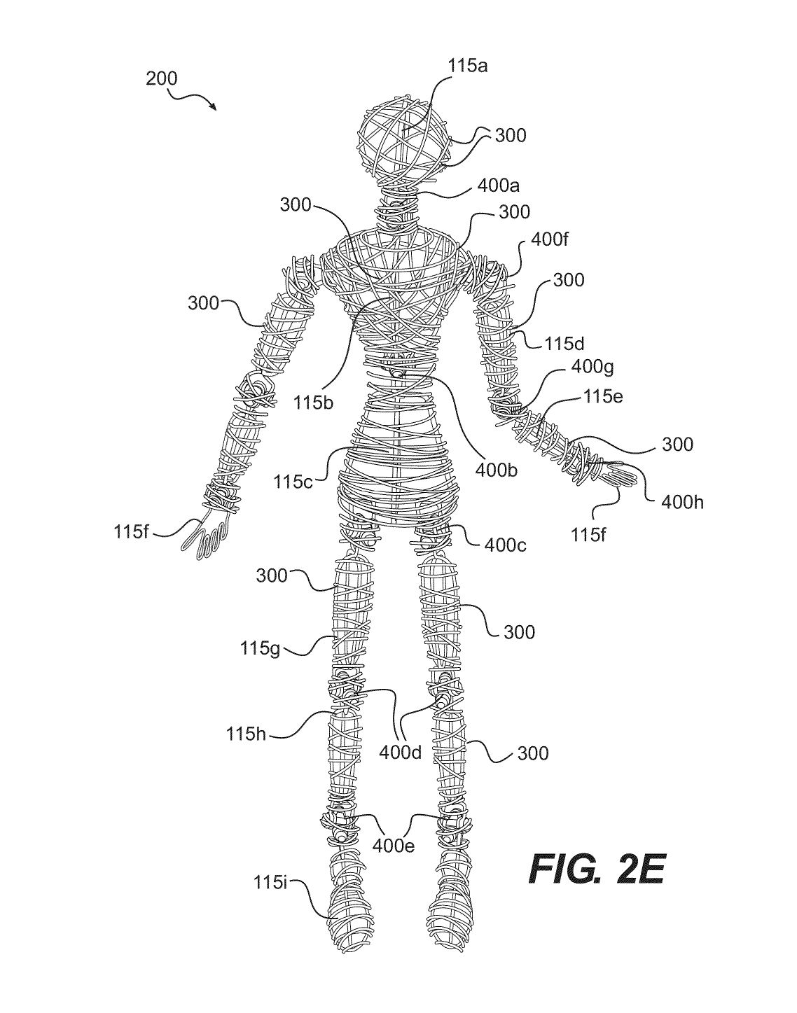

FIGS. 2A-2E illustrate examples of a second model 200 of the present invention. FIGS. 2A and 2B illustrate a second model 200 with all two-way open joints (described in FIGS. 4A and 4B). FIG. 2C illustrates a second model 200 with a combination of two-way open joints and three-way open joints (described in FIGS. 4C and 4D). FIGS. 2D and 2E illustrate a second model 200 with all two-way closed joints (described in FIGS. 4E and 4F). Second model 200 can be any size provided the proportions are recognizable as human.

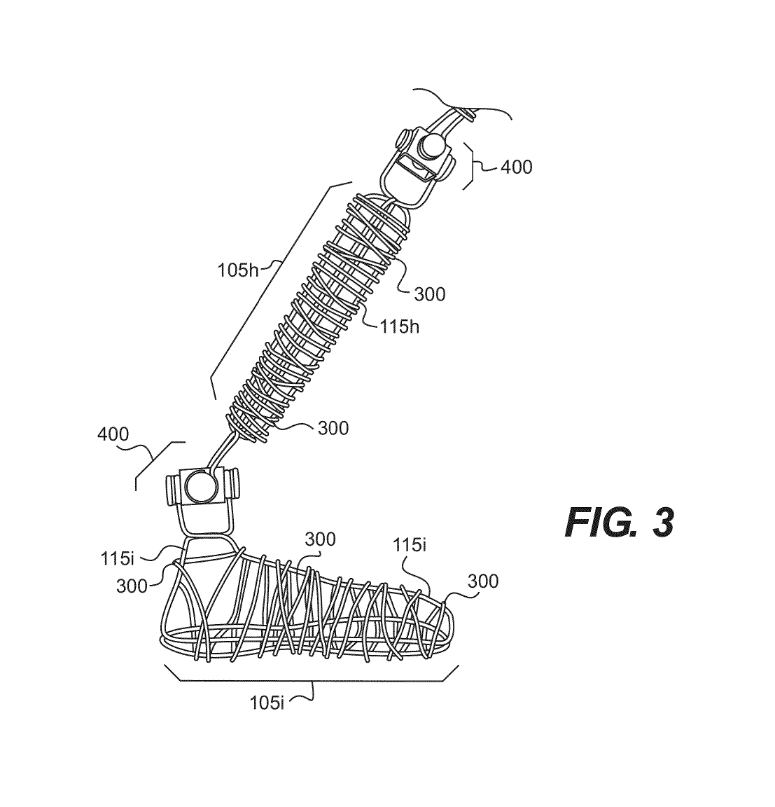

Second model 200 includes all of the elements of first model 100 and an external wire frame 300 (shown in more detail in FIG. 3).

In second model 200, each body segment 105 is made from a corresponding internal frame body segment 115 and may be surrounded by wire of the external frame 300. For example, head segment 105a contains an internal frame head segment 115a surrounded by wire 300; chest segment 105b contains an internal frame chest segment 115b surrounded by wire 300; pelvis segment 105c contains an internal frame pelvis segment 115c surrounded by wire 300; each upper arm segment 105d contains an internal frame upper arm segment 115d surrounded by wire 300; each forearm segment 105e contains an internal frame forearm segment 115e surrounded by wire 300; each hand segment 105f contains an internal frame hand segment 115f; each upper leg segment 105g contains an internal frame upper leg segment 115g surrounded by wire 300; each lower leg segment 105h contains an internal frame lower leg segment 115f surrounded by wire 300; and each foot segment 105i contains an internal frame foot segment 115i surrounded by wire 300.

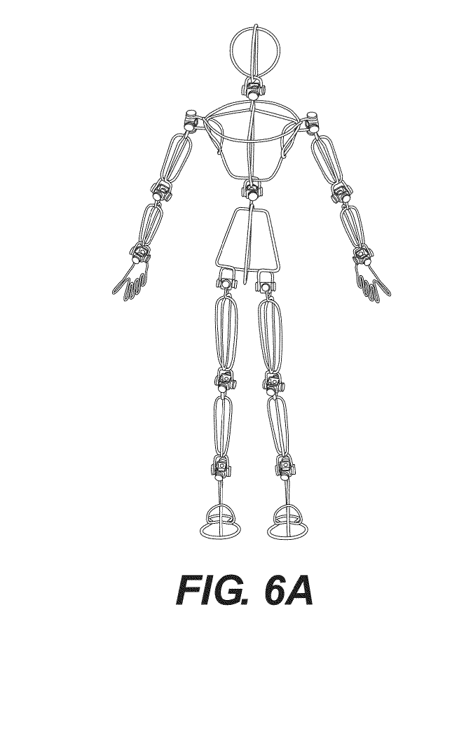

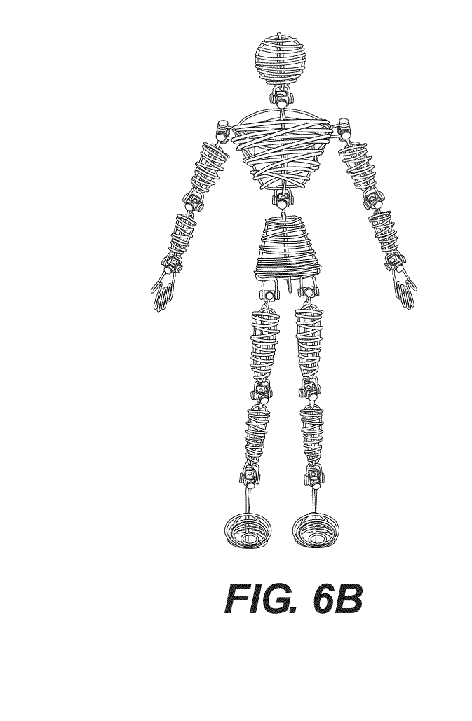

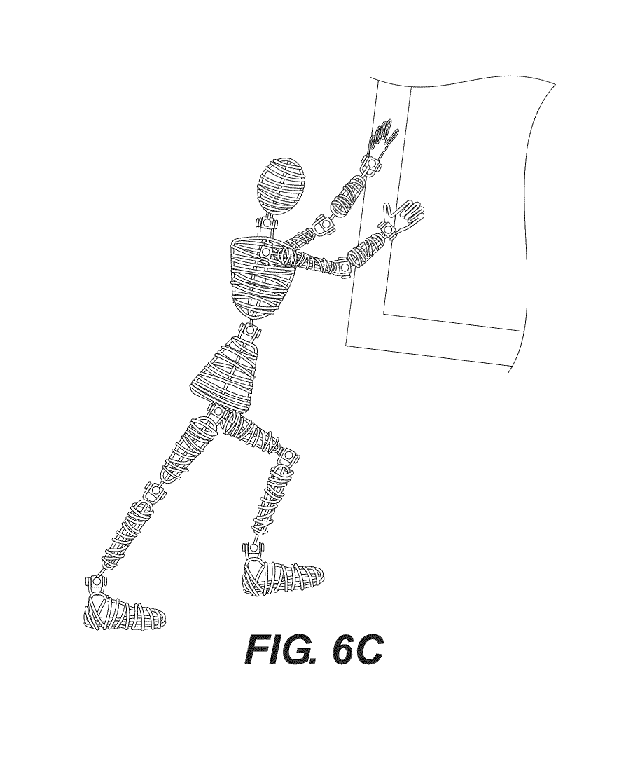

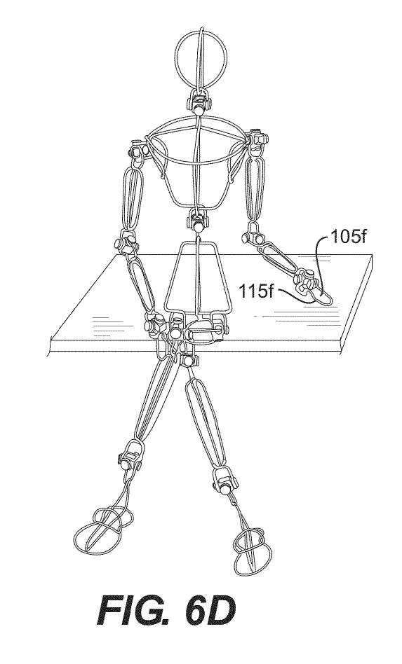

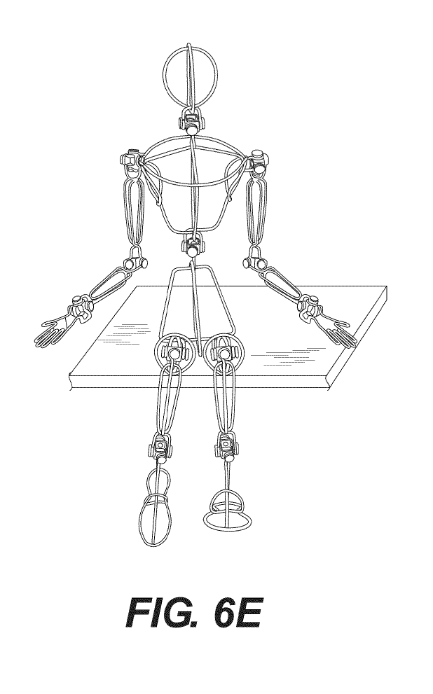

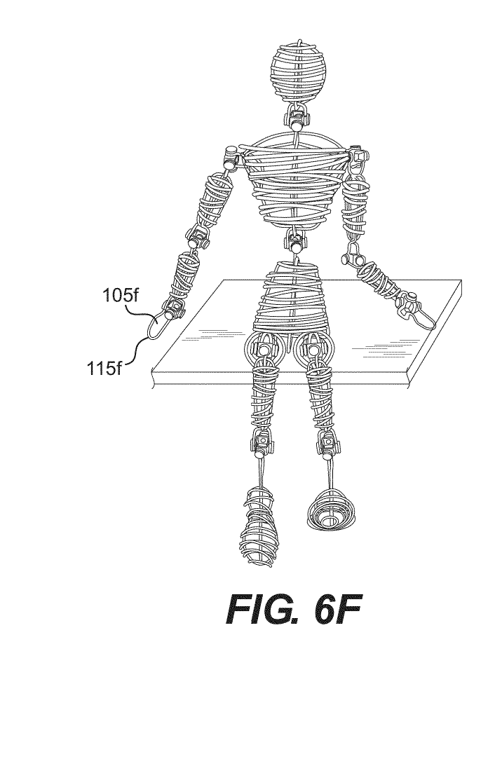

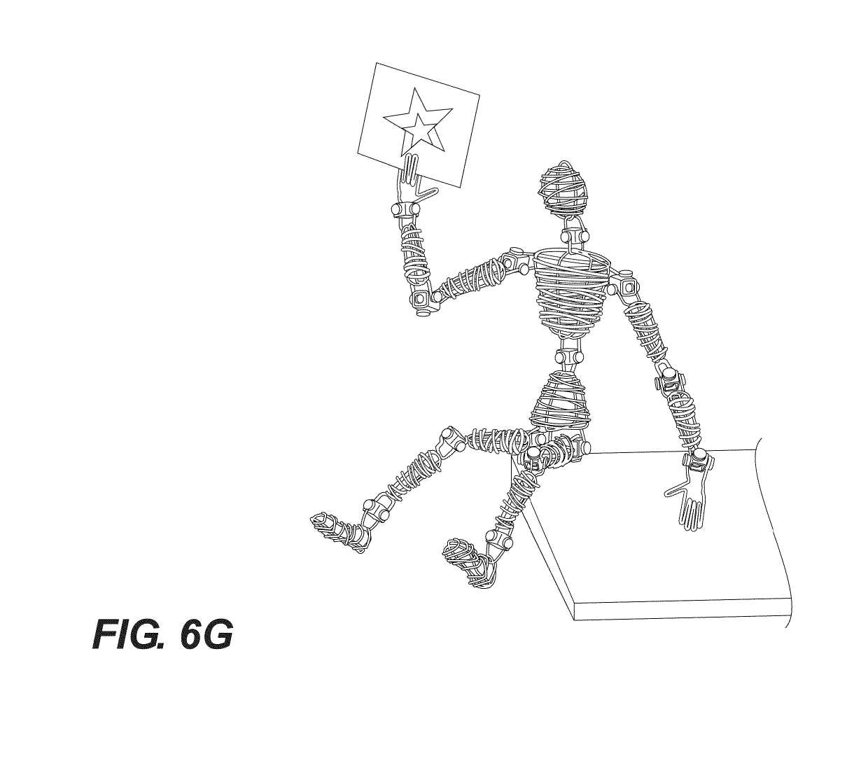

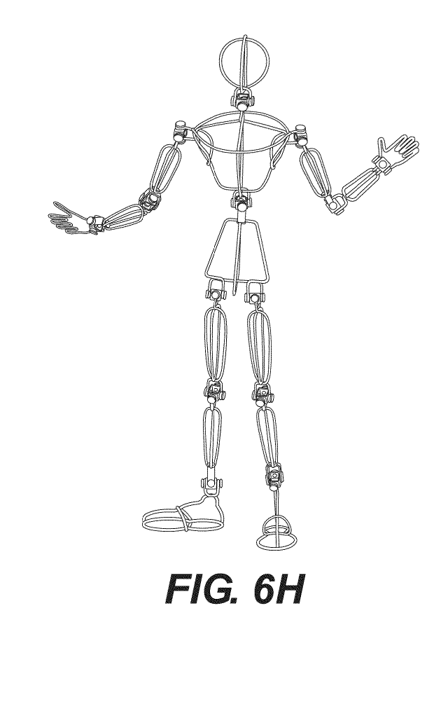

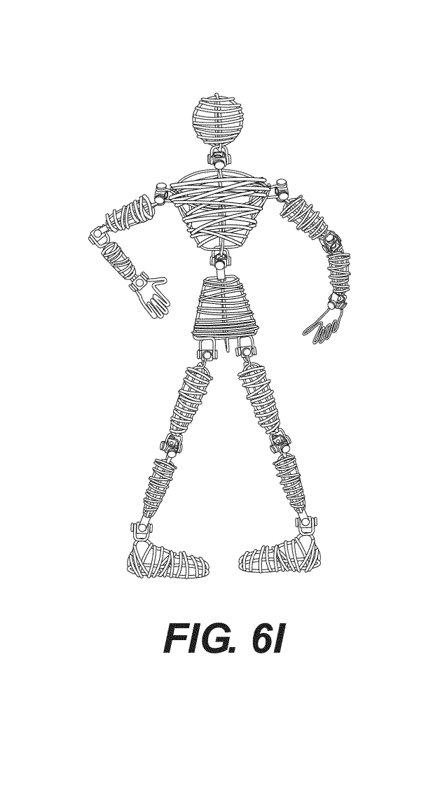

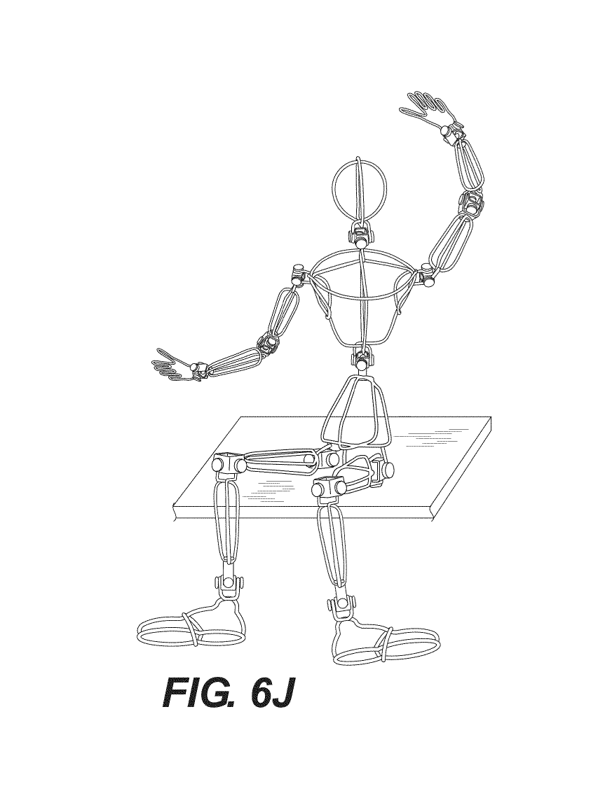

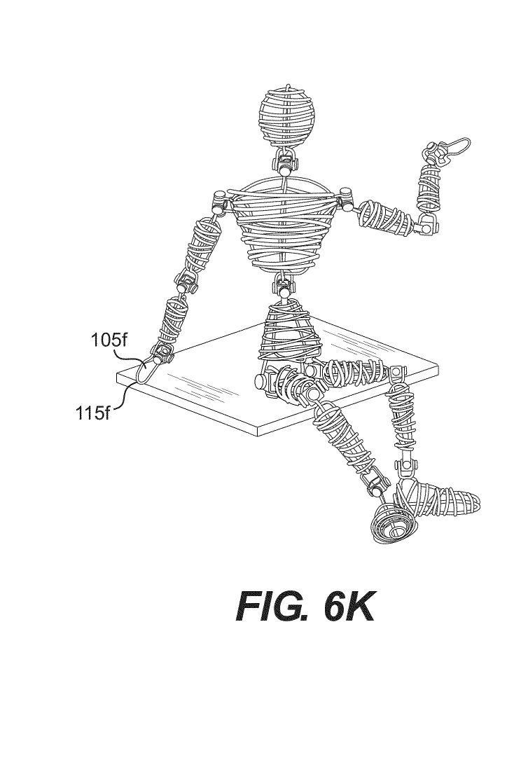

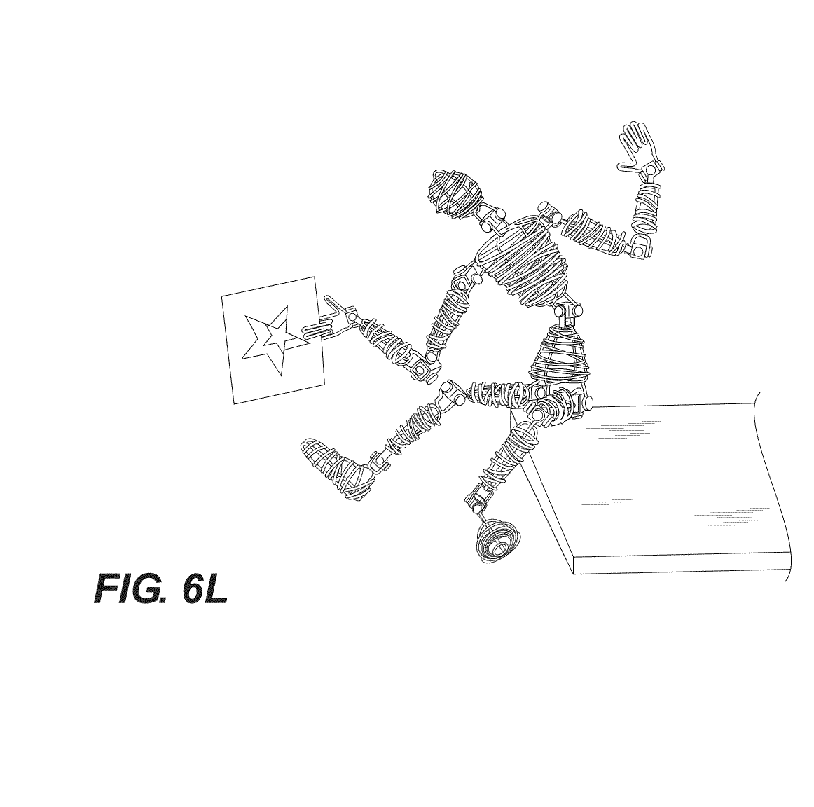

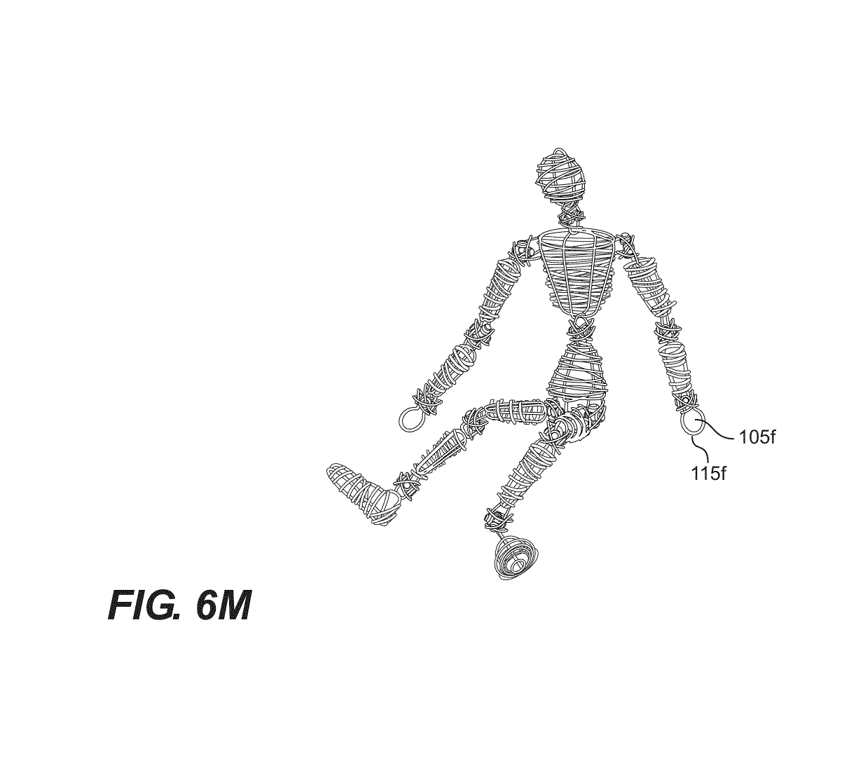

External wire 300 is wrapped around internal frame foot segments 115i in such a manner that the bottom of the foot segments 105i remain flat, enabling model 200 to stand on a flat surface with no additional support. As shown in FIGS. 2A and 2B, Internal frame hand segments 115f may remain free of external wire 300 to allow the “fingers” to hold small objects (see FIG. 6G). In other embodiments (not shown) internal frame hand segments 115f may also be wrapped in wire 300.

As shown in FIGS. 2A, 2C and 2D, external wire 300 may be wrapped around internal body segments 115 but not wrapped around joints 400. As shown in FIGS. 2B and 2E external wire 300 may be wrapped around both internal body segments 115 and joints 400.

In the examples shown, the models 100, 200 have joints that are uniform in size. In other examples (not shown) different joints may be of different sizes. In one example, the waist joint may be larger than the other joints. In other example, the hip joints may be larger than the other joints. In another example, the waist joint and the hip joints may be larger than the other joints.

FIG. 3 illustrates a portion of second model 200 from FIG. 2A showing external frame 300. External frame 300 is comprised of wire wrapped around internal frame 115. The wire of external frame 300 can be made of any material capable of wrapping around internal frame 115. By way of example, the wire can be made of metal (such as, for example, stainless steel, iron, copper, aluminum, epoxy coated steel, vinyl coated wire), plastic, or any other suitable material. The wire can retain the color of the underlying material or it can be changed to another color by painting, dying, coating, or any other means capable of changing the color.

External frame 300 is wrapped around each internal frame body segment 115 in such a way that it provides a general appearance of the corresponding body part of a human being. For example, as shown in FIG. 3, external frame 300 is wrapped around internal frame lower leg segment 115h in such a way that the resulting lower leg segment 105h generally resembles the lower leg shape of a human being. Similarly, external frame 300 is wrapped around internal frame foot segment 115i in such a way that the resulting foot segment 105i generally resembles the foot shape of a human being.

External frame 300 can be wrapped around internal frame 115 by any means capable of disposing external frame 300 around internal frame 115. By way of example, external frame 300 can be wrapped around internal frame 115 by hand or by machine or by a combination of the two.

External frame 300 may be comprised of any number of wires. For example, external frame 300 may be one continuous wire that is wrapped around all of internal frame body segments 115. External frame 300 may include several wires, each of which is wrapped around a separate internal frame body segment 115. External frame 300 may also be several wires and more than one wire may be wrapped around each internal frame body segment 115. Any number of wires can be wrapped around any number of internal frame body segments 115.

FIG. 4A illustrates one example of a joint 400 of the present invention, referred to as a “two-way open joint” 402. FIG. 4B illustrates an exploded view of the two-way open joint 402 of FIG. 4A. Two-way open joint 402 is comprised of four hinges 410, namely a first hinge 410a, a second hinge 410b, a third hinge 410c, and a fourth hinge 410d. First hinge 410a and second hinge 410b together make up the first hinge pair. Third hinge 410c and fourth hinge 410d together make up the second hinge pair. Hinges 410 are arranged around a square bracket 440. First hinge 410a is located across from second hinge 410b on square bracket 440. Third hinge 410c is located at a 90 degree angle from first hinge 410a and second hinge 410b and across from fourth hinge 410d on square bracket 440. Fourth hinge 410d is located at a 90 degree angle from first hinge 410a and second hinge 410b and across from third hinge 410c on square bracket 440.

In the example shown in FIGS. 4A and 4B, each hinge 410 is made from a rivet 450 installed on square bracket 440 over a portion of internal frame 115. In other examples (not shown), other mechanical fasteners may be used instead of rivets at one or more hinges, such as, for example, screws or nuts and bolts. When rivets 450 are used, rivets may be any combination of all solid rivets, all blind rivets, or a combination of solid and blind rivets. This configuration allows movement of internal frame 115 around rivet 450 and secures internal frame 115 to rivet 450, thereby attaching joints 400 to model 100 and 200 (see FIGS. 1A, 2A and 2B). Square bracket 440 may be made of any material suitable for holding rivets 450. By way of example, square bracket 440 may be made of metal (such as, for example, stainless steel, iron, copper, aluminum, epoxy coated steel, vinyl coated steel, steel with an anodized finish), plastic, or any other material capable of holding rivets 450. Rivet 450 may be made of any material suitable for installation on square bracket 440. By way of example, rivet 450 may be metal (such as, for example, aluminum, stainless steel, iron, copper, aluminum, epoxy coated steel, vinyl coated steel, steel with an anodized finish), plastic (such as, for example, polyprolylene and ABS), or any other suitable material. The factory head 450a of rivet 450 is positioned on the outside of internal frame 115 and the shop head 450b of rivet 450 is positioned on the inside of square bracket 440. In one example, a spacer 460 is located between factory head 450a of rivet and internal frame 115. Spacer 460 provides a cushion between factory head 450a of rivet and internal frame 115 and assists in maintaining resistance between internal frame 115 and joint 400, enhancing the ability of body segments 105 to maintain poses. Spacer 460 can be made of any material capable of cushioning joint 400. By way of example, spacer 460 may be made of metal (such as, for example, stainless steel, iron, copper, aluminum, epoxy coated steel, vinyl coated steel, steel with an anodized finish), plastic (such as, for example, acetate or polyvinyl chloride) or any other suitable material. Spacer 460 may be ring shaped as shown in FIGS. 4A and 4B or it may be conical shaped (not shown in relation to two-way open joint) or wave shaped (not shown in relation to two-way open joint) or any other shape capable of cushioning joint 400. Conical shaped spacers and wave shaped spacers may be any flexible material capable of retaining their shape under pressure, such as, for example, spring metal. A particular joint may have no spacers, one type of spacer, or a combination of two or more types of spacers. The particular assembly shown is for illustration purposes only and is not intended to limit the scope of the invention.

FIG. 4C illustrates another example of a joint 400 of the present invention, referred to as a “three-way open joint” 403. FIGS. 4Ci and 4Cii illustrate other examples of the “three-way open joint” 403. FIG. 4D illustrates an exploded view of the three-way open joint 403 of FIG. 4C. Three-way open joint 403 is comprised of five hinges 410, namely a first hinge 410a, a second hinge 410b, a third hinge 410c, a fourth hinge 410d, and a fifth hinge 410e. First hinge 410a and second hinge 410b together make up the first hinge pair. Third hinge 410c and fourth hinge 410d together make up the second hinge pair. Fifth hinge 410e is not paired with another hinge. First hinge 410a, second hinge 410b, third hinge 410c, and fourth hinge 410d are arranged around square bracket 440. Fifth hinge 410e is located on a body segment 105 adjacent to square bracket 440. First hinge 410a is coaxial with and is located across from second hinge 410b on square bracket 440. Third hinge 410c is located at a 90 degree angle from first hinge 410a and second hinge 410b and across from and coaxial with fourth hinge 410d on square bracket 440. Fourth hinge 410d is located at a 90 degree angle from first hinge 410a and second hinge 410b and across from and coaxial with third hinge 410c on square bracket 440. Fifth hinge 410e is located on a body segment 105 adjacent to square bracket 440 in a different plane from first hinge 410a, second hinge 410b, third hinge 410c, and fourth hinge 410d and has an axis that is preferably orthogonal to the axes of first hinge 410a, second hinge 410b, third hinge 410c, and fourth hinge 410d.

In the example shown in FIGS. 4C and 4D, first hinge 410a and second hinge 410b are made from a rivet 450 installed on square bracket 440 through an end of a horseshoe bracket 470. Third hinge 410c and fourth hinge 410d are made from a rivet 450 installed on square bracket 440 over a portion of internal frame 115 of the human model. Fifth hinge 410e is made from a rivet 450 installed on the middle portion of horseshoe bracket 470 over a portion of internal frame 115.

In other examples (not shown), other mechanical fasteners may be used instead of rivets at one or more hinges, such as, for example, screws or nuts and bolts. When rivets 450 are used, the rivets may be any combination of all solid rivets (see FIGS. 4C and 4D), all blind rivets (see FIGS. 4Ci, 4Cii, 4Di and 4Dii), or a combination of solid and blind rivets (not shown).

This configuration allows movement of internal frame 115 or horseshoe bracket 470 around rivet 450 and secures internal frame 115 or horseshoe bracket 470 to rivet 450, thereby attaching joints 403 to body segments of a model 100 and 200. Square bracket 440 may be made of any material suitable for holding rivets 450. By way of example, square bracket 440 may be made of metal (such as, for example, stainless steel, iron, copper, aluminum, epoxy coated steel, vinyl coated steel, steel with an anodized finish), plastic or any other material capable of holding rivets 450. Horseshoe bracket 470 may be made of any suitable material. By way of example, horseshoe bracket 470 may be made of metal (such as, for example, stainless steel, iron, copper, aluminum, epoxy coated steel, vinyl coated steel, steel with an anodized finish), plastic, or any other material capable of holding rivets 450. Rivet 450 may be made of any material suitable for installation on square bracket 440 or horseshoe bracket 470. By way of example, rivet 450 may be metal (such as, for example, aluminum, stainless steel, iron, copper, aluminum, epoxy coated steel, vinyl coated steel, steel with an anodized finish), plastic (such as, for example, polyprolylene and ABS), or any other suitable material.

In the first hinge 410a and second hinge 410b, the factory head 450a of rivet 450 is positioned on the outside of horseshoe bracket 470 and the shop head 450b of rivet 450 is positioned on the inside of square bracket 440. In the third hinge 410c and fourth hinge 410d, the factory head 450a of rivet 450 is positioned on the outside of external frame 115 and the shop head 450b of rivet 450 is positioned on the inside of square bracket 440. In the fifth hinge 410e, the factory head 450a of rivet 450 is positioned on the outside of internal frame 115 and the shop head 450b of rivet 450 is positioned on the inside of horseshoe bracket 470. In one example, a spacer 460 is located between factory head 450a of rivet and horseshoe bracket 470 in first hinge 410a and second hinge 410b. In another example, a spacer 460 is located between factory head 450a of rivet and internal frame 115 in third hinge 410c and fourth hinge 410c. In another example, a spacer 460 is located between factory head 450a of rivet and internal frame 115 in fifth hinge 410e. In another example, a spacer 460 is located between internal frame 115 and horseshoe bracket 470 in fifth hinge 410e. Spacer 460 provides a cushion between parts of the joints and assists in maintaining resistance between internal frame 115 and joint 400, enhancing the ability of body segments 105 to maintain poses. Spacer 460 can be made of any material capable of cushioning joint 400. By way of example, spacer 460 may be made of metal (such as, for example, stainless steel, iron, copper, aluminum, epoxy coated steel, vinyl coated steel, steel with an anodized finish), plastic (such as, for example, acetate or polyvinyl chloride) or any other suitable material. Spacer 460 may be ring shaped as shown in FIGS. 4C and 4D or it may be conical shaped as shown in FIG. 4Di or wave shaped as shown in FIG. 4Dii or any other shape capable of cushioning joint 400. Conical shaped spacers and wave shaped spacers may be any flexible material capable of retaining their shape under pressure, such as, for example, spring metal. A particular joint may have no spacers, one type of spacer, or a combination of two or more types of spacers. The particular assembly shown is for illustration purposes only and is not intended to limit the scope of the invention.

FIG. 4E illustrates another example of a joint 400 of the present invention, referred to as a “two-way closed joint” 404. FIG. 4F illustrates an exploded view of the two-way closed joint 404 of FIG. 4E. Two-way closed joint 404 is comprised of four hinges 410, namely a first hinge 410a, a second hinge 410b, a third hinge 410c, and a fourth hinge 410d. First hinge 410a and second hinge 410b together make up the first hinge pair. Third hinge 410c and fourth hinge 410d together make up the second hinge pair. Hinges 410 are arranged around a piece of sheet metal 480. First hinge 410a is located across from second hinge 410b on sheet metal 480. Third hinge 410c is located at a 90 degree angle from first hinge 410a and second hinge 410b and across from fourth hinge 410d on sheet metal 480. Fourth hinge 410d is located at a 90 degree angle from first hinge 410a and second hinge 410b and across from third hinge 410c on sheet metal 480.

In the example shown in FIGS. 4E and 4F, each hinge 410 is made from a rivet 450 installed on sheet metal 480 over a portion of internal frame 115. In other examples (not shown), other mechanical fasteners may be used instead of rivets at one or more hinges, such as, for example, screws or nuts and bolts. When rivets 450 are used, rivets may be any combination of all solid rivets, all blind rivets, or a combination of solid and blind rivets. This configuration allows movement of internal frame 115 around rivet 450 and secures internal frame 115 to rivet 450, thereby attaching joints 400 to model 100 and 200 (see FIGS. 1C, 2D and 2E). Sheet metal 480 may be made of any metal suitable for holding rivets 450, such as, for example, stainless steel, iron, copper, aluminum, epoxy coated steel, vinyl coated steel, steel with an anodized finish). Other materials may be substituted for sheet metal 480, such as, for example, plastic or any other material capable of holding rivets 450. Rivet 450 may be made of any material suitable for installation on sheet metal 480. By way of example, rivet 450 may be metal (such as, for example, aluminum, stainless steel, iron, copper, aluminum, epoxy coated steel, vinyl coated steel, steel with an anodized finish), plastic (such as, for example, polyprolylene and ABS), or any other suitable material. The factory head 450a of rivet 450 is positioned on the outside of internal frame 115 and the shop head 450b of rivet 450 is positioned on the inside of sheet metal 480. In one example (not shown), a spacer may be located between factory head 450a of rivet and internal frame 115. Spacer provides a cushion between factory head 450a of rivet and internal frame 115 and assists in maintaining resistance between internal frame 115 and joint 400, enhancing the ability of body segments 105 to maintain poses. Spacer can be made of any material capable of cushioning joint 400. By way of example, spacer may be made of metal (such as, for example, stainless steel, iron, copper, aluminum, epoxy coated steel, vinyl coated steel, steel with an anodized finish), plastic (such as, for example, acetate or polyvinyl chloride) or any other suitable material. Spacer may be ring shaped, conical shaped, wave shaped, or any other shape capable of cushioning joint 400. Conical shaped spacers and wave shaped spacers may be any flexible material capable of retaining their shape under pressure, such as, for example, spring metal. A particular joint may have no spacers, one type of spacer, or a combination of two or more types of spacers. The particular assembly shown is for illustration purposes only and is not intended to limit the scope of the invention.

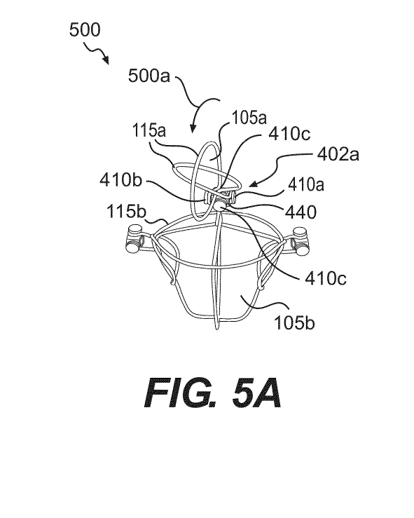

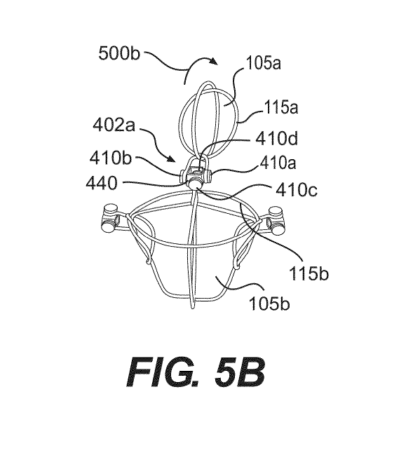

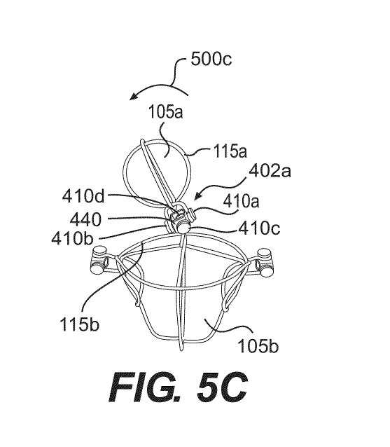

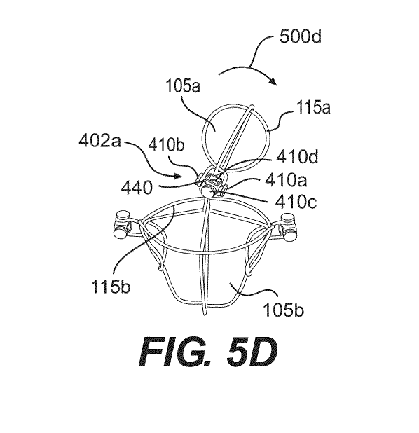

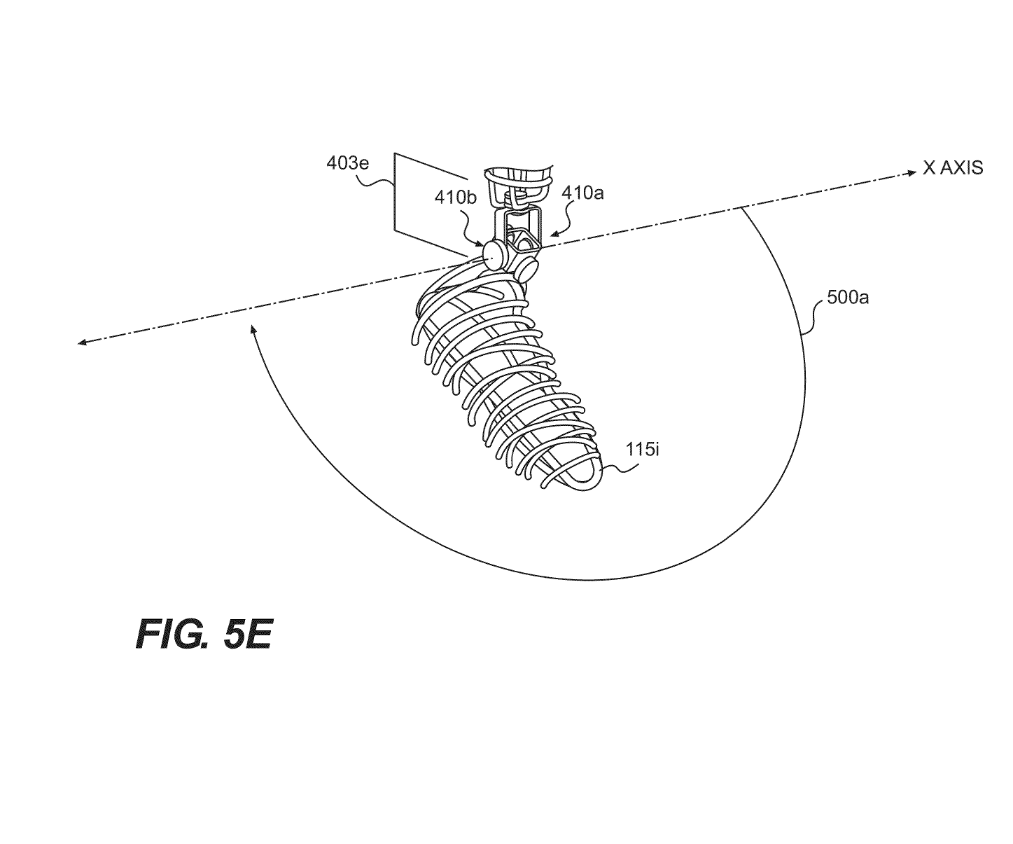

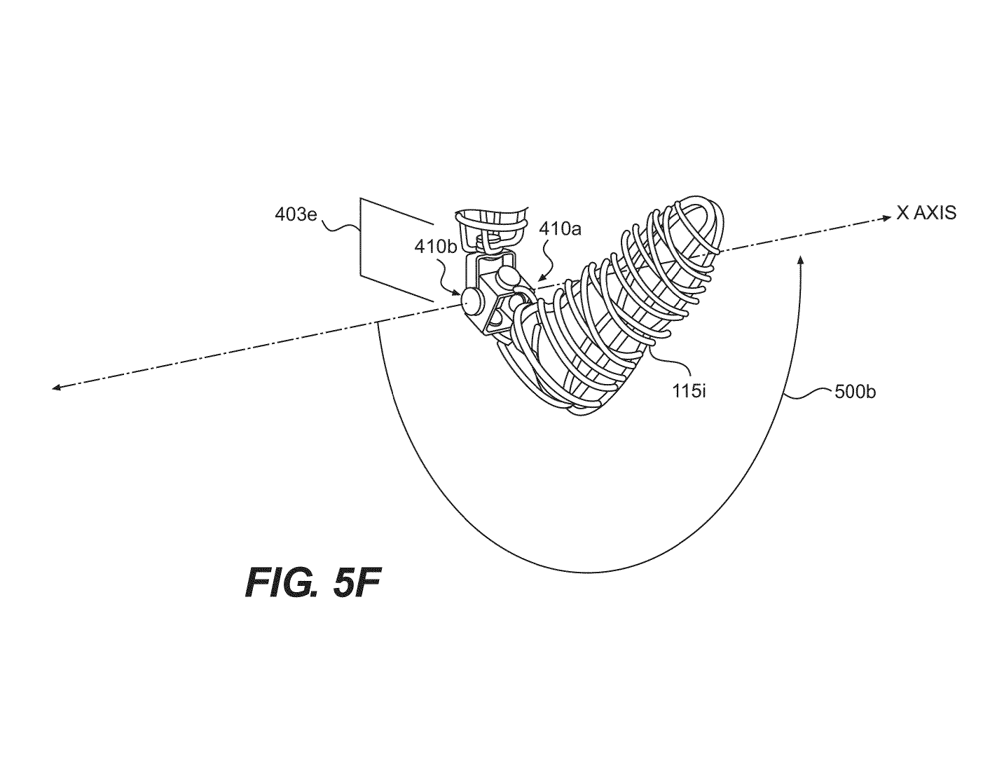

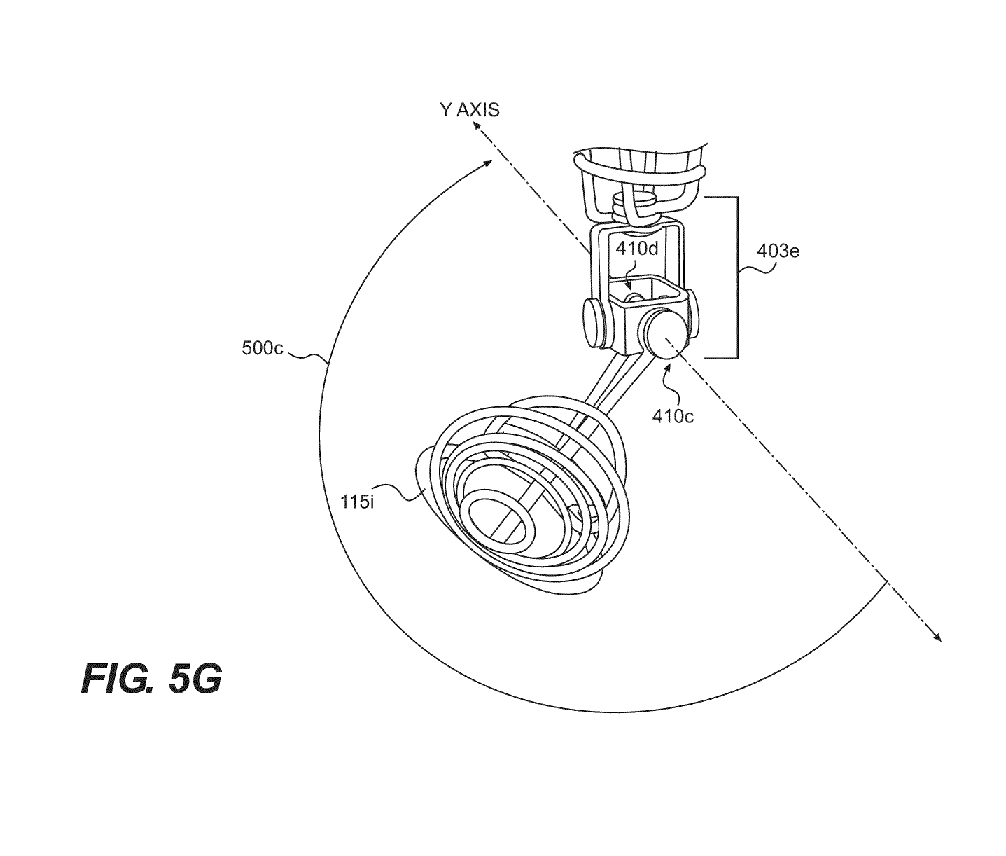

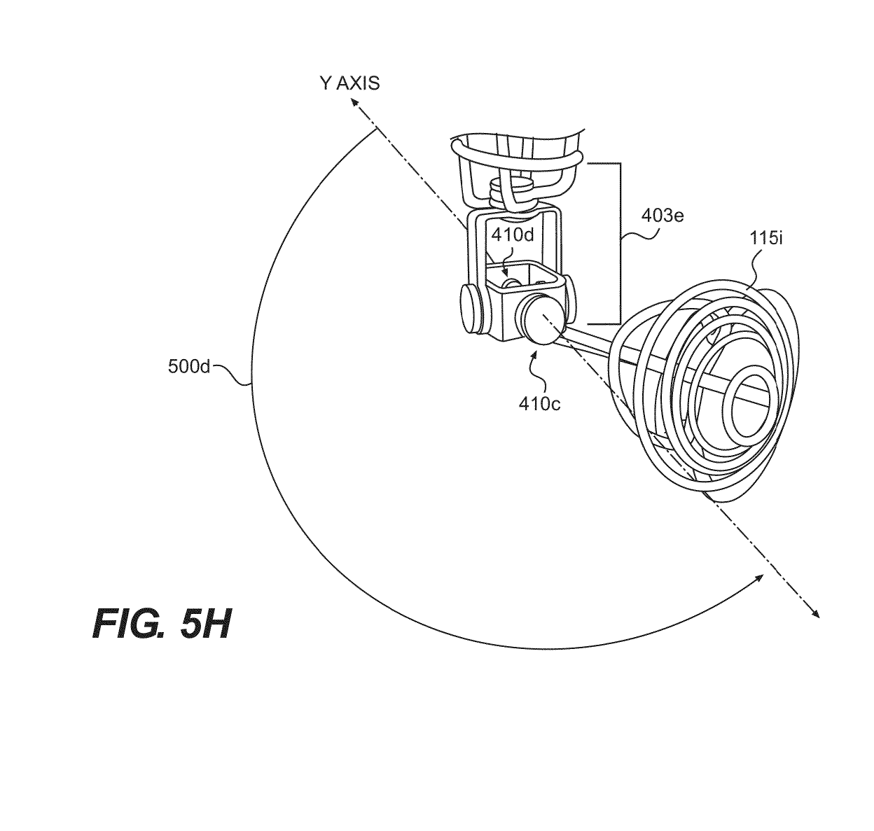

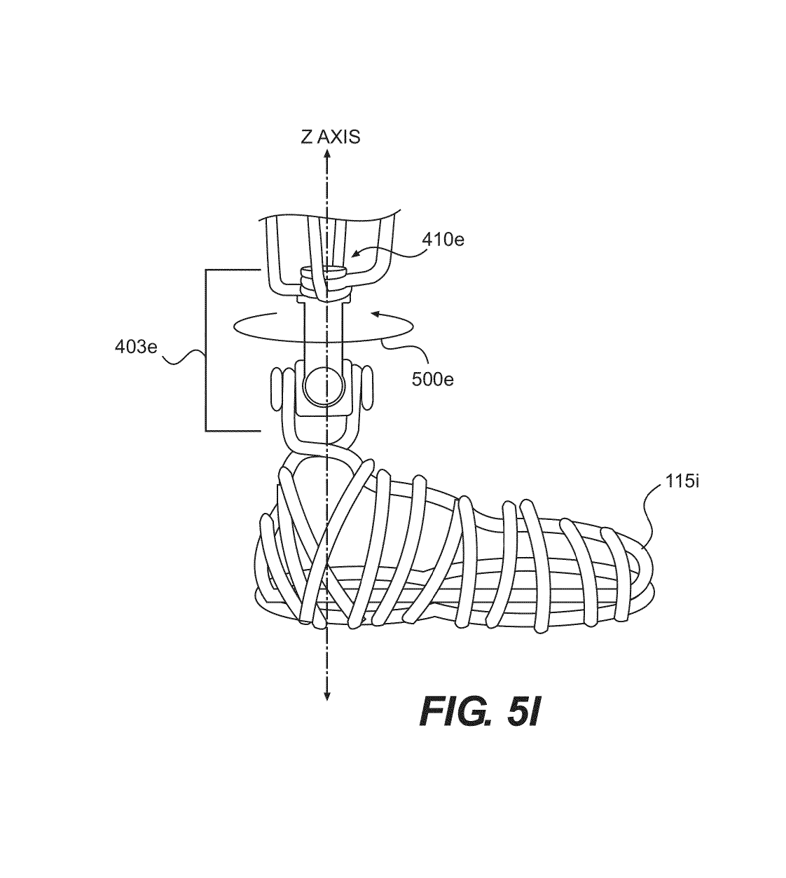

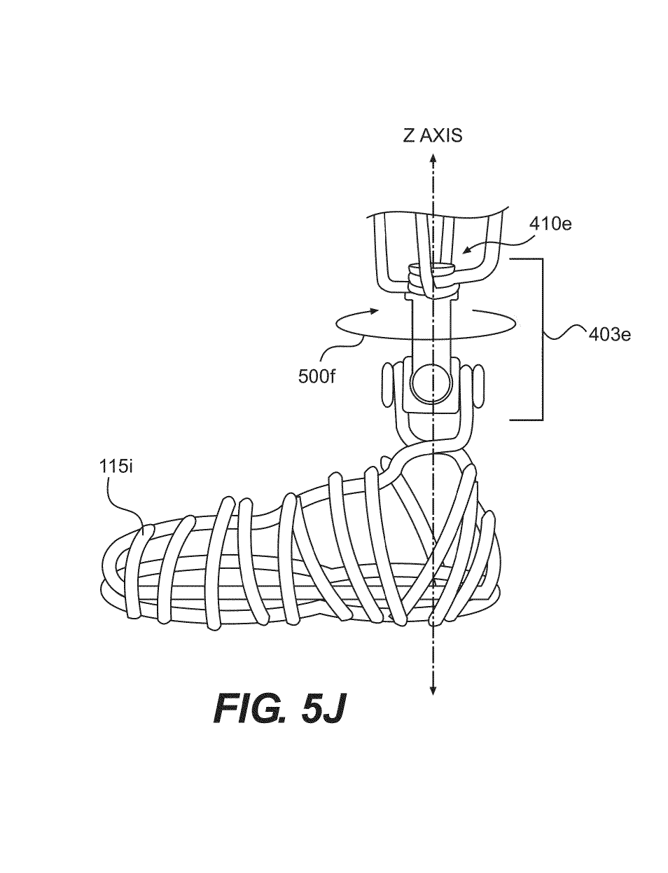

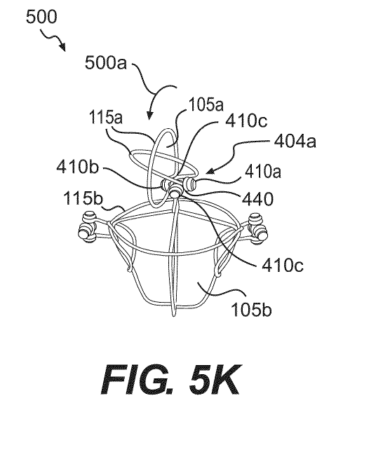

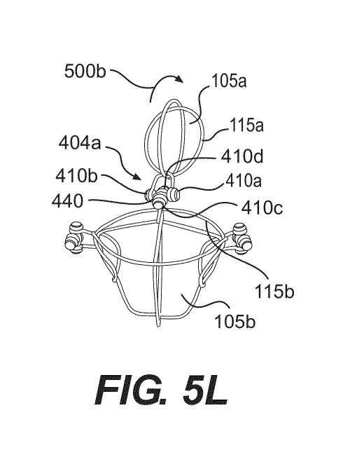

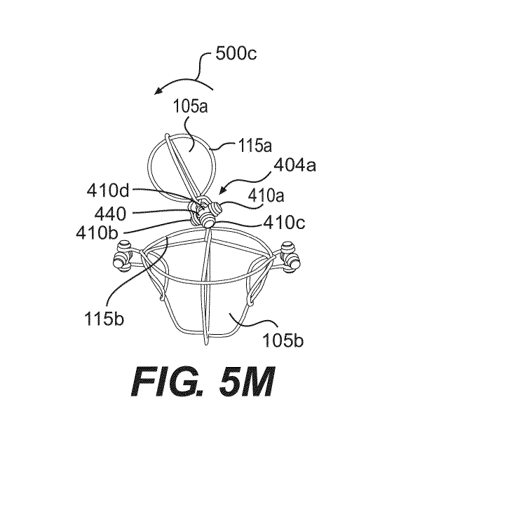

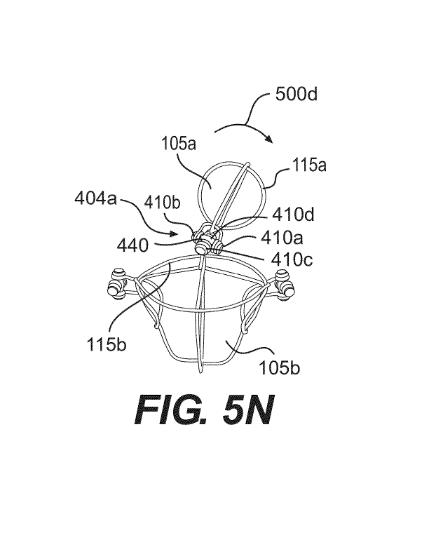

FIGS. 5A-5D illustrate the movement 500 of two-way open joint 402 in four directions along two axes. FIGS. 5E-5J illustrate the movement 500 of the three-way open joint 403 in six directions. FIGS. 5K-5N illustrate the movement of 500 of the two-way closed joint 404 on four directions.

Specifically, FIGS. 5A-5D illustrate the movement of internal frame head segment 115a relative to internal frame chest segment 115b via the movement of two-way open neck joint 402a. Two-way open neck joint 402a is representative of all of the two-way open joints 402 in the models 100 and 200 (see FIGS. 1A, 2A and 2B) and is shown to illustrate how each of the two-way open joints 402 function.

FIG. 5A illustrates the movement of internal frame head segment 115a in a forward direction 500a along a first axis (for example, an X axis). To move in forward direction 500a, first hinge pair (comprising first hinge 410a and second hinge 410b) rotate forward while square bracket 440 and second hinge pair (comprising third hinge 410c and fourth hinge 410d) remain stationary.

FIG. 5B illustrates the movement of internal frame head segment 115a in a backward direction 500b along the first axis (X axis). To move in backward direction 500b, first hinge pair (comprising first hinge 410a and second hinge 410b) rotate backward while square bracket 440 and second hinge pair (comprising third hinge 410c and fourth hinge 410d) remain stationary.

FIG. 5C illustrates the movement of internal frame head segment 115a in a right side direction 500c along the second axis (for example, a Y axis). To move in right side direction 500c, second hinge pair (comprising third hinge 410c and fourth hinge 410d) rotate to the right.

FIG. 5D illustrates the movement of internal frame head segment 115a in a left side direction 500d along the second axis (Y axis). To move in left side direction 500d, second hinge pair (comprising third hinge 410c and fourth hinge 410d) rotates to the left.

Thus, two-way open neck joint 402a (and the other two-way open joints 402, not shown) are each capable of moving in four directions—front 500a, back 500b, right side 500c, and left side 500d—along two axes (a front-back or X axis and a right-left or Y axis). Each hinge pair is capable of moving along one axis—the first hinge pair (comprising first hinge 410a and second hinge 410b) is capable of moving along the first axis (the front-back or X axis) and the second hinge pair (comprising third hinge 410c and fourth hinge 410d) is capable of moving along the second axis (the right-left or Y axis). The front-back direction of the first axis is 90 degrees from the right-left direction of the second axis.

Such range of movement allows each body segment 105 to be positioned in numerous positions, enabling the models 100 and 200 (see FIGS. 1, 2A and 2B) to be configured in a variety of human like poses (see FIGS. 6A-6G).

FIGS. 5E-5J illustrate the movement of internal frame foot segment 115i relative to internal frame lower leg segment 115h via the movement of three-way open ankle joint 403e. Three-way open ankle joint 403e is representative of all of the three-way open joints 403 in the models 100 and 200 (see FIGS. 1B, and 2C) and is shown to illustrate how each of the three-way open joints 403 function.

FIG. 5E illustrates the movement of internal frame foot segment 115i in a forward direction 500a along a first axis (for example, an X axis). To move in forward direction 500a, first hinge pair (comprising first hinge 410a and second hinge 410b) rotates forward.

FIG. 5F illustrates the movement of internal frame foot segment 115i in a backward direction 500b along the first axis (X axis). To move in backward direction 500b, first hinge pair (comprising first hinge 410a and second hinge 410b) rotates backward.

FIG. 5G illustrates the movement of internal frame foot segment 115i in a right side direction 500c along a second axis (for example, a Y axis). To move in right side direction 500c, second hinge pair (comprising third hinge 410c and fourth hinge 410d) rotates to the right.

FIG. 5H illustrates the movement of internal frame foot segment 115i in a left side direction 500d along the second axis (Y axis). To move in left side direction 500d, second hinge pair (comprising third hinge 410c and fourth hinge 410d) rotates to the left.

FIG. 5I illustrates the movement of internal frame foot segment 115i in an inside direction 500e along a third axis (for example, a Z axis). To move in inside direction 500e, fifth hinge 410e rotates inward.

FIG. 5J illustrates the movement of internal frame foot segment 115i in an outside side direction 500f along the third axis (Z axis). To move in outside direction 500f, fifth hinge 410e rotates outward.

The fifth hinge may also be capable of rotating 360 degrees or more in either the inside 500e direction or outside 500f direction (along the Z axis). Essentially, the third hinge may be capable of continuously rotating around the fifth hinge (third axis or Z axis) and stopping at any point within or beyond the 360 degree radius.

Thus, three-way open ankle joint 403e (and the other three-way open joints 403, not shown) are each capable of moving in six directions—front 500a, back 500b, right side 500c, left side 500d, inside 500e, and outside 500f—along three axes (a front-back or X axis, a right-left or Y axis, and an inside-outside or Z axis). Each hinge pair is capable of moving along one axis—the first hinge pair (comprising first hinge 410a and second hinge 410b) is capable of moving along the first axis (the front-back or X axis) and the second hinge pair (comprising third hinge 410c and fourth hinge 410d) is capable of moving along the second axis (the right-left or Y axis). In addition, the fifth hinge 410e is capable of moving along one axis—the inside-outside or Z axis. The front-back direction of the first axis is 90 degrees from the right-left direction of the second axis and 90 degrees from the inside-outside direction of the third axis in a different plane.

Such three-way joints allow attached body segments to be positioned in numerous positions, enabling the models 100 and 200 (see FIGS. 1B and 2C) to be configured in a variety of life-like poses (see FIGS. 6H-6L).

FIGS. 5K-5N illustrate the movement of internal frame head segment 115a relative to internal frame chest segment 115b via the movement of two-way closed neck joint 404a. Two-way closed neck joint 404a is representative of all of the two-way closed joints 404 in the models 100 and 200 (see FIGS. 1C, 2D and 2E) and is shown to illustrate how each of the two-way closed joints 404 function.

FIG. 5K illustrates the movement of internal frame head segment 115a in a forward direction 500a along a first axis (for example, an X axis). To move in forward direction 500a, first hinge pair (comprising first hinge 410a and second hinge 410b) rotates forward while sheet metal 480 and second hinge pair (comprising third hinge 410c and fourth hinge 410d) remain stationary.

FIG. 5L illustrates the movement of internal frame head segment 115a in a backward direction 500b along the first axis (X axis). To move in backward direction 500b, first hinge pair (comprising first hinge 410a and second hinge 410b) rotates backward while sheet metal 480 and second hinge pair (comprising third hinge 410c and fourth hinge 410d) remain stationary.

FIG. 5M illustrates the movement of internal frame head segment 115a in a right side direction 500c along the second axis (for example, a Y axis). To move in right side direction 500c, second hinge pair (comprising third hinge 410c and fourth hinge 410d) rotates to the right.

FIG. 5N illustrates the movement of internal frame head segment 115a in a left side direction 500d along the second axis (Y axis). To move in left side direction 500d, second hinge pair (comprising third hinge 410c and fourth hinge 410d) rotates to the left.

Thus, two-way closed neck joint 404a (and the other two-way closed joints 404, not shown) are each capable of moving in four directions—front 500a, back 500b, right side 500c, and left side 500d—along two axes (a front-back or X axis and a right-left or Y axis). Each hinge pair is capable of moving along one axis—the first hinge pair (comprising first hinge 410a and second hinge 410b) is capable of moving along the first axis (the front-back or X axis) and the second hinge pair (comprising third hinge 410c and fourth hinge 410d) is capable of moving along the second axis (the right-left or Y axis). The front-back direction of the first axis is 90 degrees from the right-left direction of the second axis.

Such range of movement allows each body segment 105 to be positioned in numerous positions, enabling the models 100 and 200 (see FIGS. 1C, 2D and 2E) to be configured in a variety of human like poses (see FIG. 6M).

Any model may have any combination of two-way joints, three-way joints, open joints, and closed joints. In the examples shown in FIGS. 1A, 2A, and 2B, the models 100, 200 have only two-way open joints 402. In the examples shown in FIGS. 1B and 2C, the models 100, 200 have two-way open neck joints 400a, hip joints 400c, knee joints 400d and shoulder joints 400f and three-way open waist joints 400b, ankle joints 400e, elbow joints 400g, and wrist joints 400h. In the examples shown in FIGS. 1C, 2D, and 2E, the models 100, 200 have only two-way closed joints 404. In other examples (not shown) the models may have only three-way open joints. In other examples (not shown) the model may have a variety of other combinations two-way open joints 402, three-way joints 403, two-way closed joints 404, and three-way closed joints.

FIGS. 6A-6M illustrate models 100 and 200 in a variety of poses.

FIG. 6A illustrates model 100 (from FIG. 1A) in an unaided standing position. FIG. 6B illustrates model 200 (from FIG. 2A) in unaided standing position. FIG. 6C illustrates model 200 (from FIG. 2A) in a leaning position. In FIG. 6C, model 200 (from FIG. 2A) is leaning against a device such as a computer monitor. FIG. 6D illustrates model 100 in a sitting position with crossed legs. In this illustration, the internal frame hand segments 115f of hand segments 105f are not formed into fingers, and are instead formed into a more general mitten shape. FIG. 6E illustrates model 100 (from FIG. 1A) in a sitting position with legs uncrossed. FIG. 6F illustrates model 200 (from FIG. 2A) in a sitting position with legs uncrossed. In this illustration, internal frame hand segments 115f of hand segments 105f are not formed into fingers, and are instead formed into a more general mitten shape. FIG. 6G illustrates model 200 (from FIG. 2A) in a reclined sitting position holding a paper object. FIG. 6H illustrates model 100 (from FIG. 1B) in an unaided standing position with feet turned out and upper body turned to the left side at the waist. FIG. 6I illustrates model 200 (from FIG. 2C) in unaided standing position with feet turned in and upper body turned to the right at the waist. FIG. 6J illustrates model 100 (from FIG. 1B) in a sitting position with feet turned out and body rotated at the waist. FIG. 6K illustrates model 200 (from FIG. 2C) in a sitting position with feet rotated. In this illustration, internal frame hand segments 115f of hand segments 105f are not formed into fingers, and are instead formed into a more general mitten shape. FIG. 6L illustrates model 200 (from FIG. 2C) in a reclined sitting position bent backwards with feet and hands rotated. FIG. 6M illustrates model 200 (from FIG. 2E) in a sitting position. In this illustration, internal frame hand segments 115f are not formed into fingers, and are instead formed into a more general mitten shape.

FIGS. 7A-7E(iv) illustrate additional examples of configurations of the hand segments 105f. FIG. 7A illustrates an example of the “fingers” of the internal frame hand segment bending independently of each other 700. In one example, the internal frame hand segments 115f are made of a material that is thinner than material that comprises the other internal frame segments 115. The thinner material is capable of bending, allowing the individual “fingers” to bend independently of each other. The thinner material may be any material capable of bending. In one example, the thinner material is stainless steel. In another example, the thinner material is aluminum.

FIG. 7B illustrates a bendable hand segment 700 where the internal frame hand segment 115f is configured in a crisscross pattern 710 adjacent to the wrist joint 400h. Such a configuration provides additional rigidity so that the thinner hand segment is capable of easily rotating in the two or three axes without distorting the thinner internal frame hand segment.

FIG. 7C illustrates a bendable hand segment 700 where the internal frame hand segment 115f is coupled to the wrist joint 400h by a crimp 720. In other examples, the internal frame hand segment 115f may be coupled to the wrist joint 400h by another coupling devise. Such a configuration allows the thinner hand segment to move without distorting the thinner internal frame hand segment.

FIG. 7D illustrates a bendable hand segment 700 where the internal frame hand segment 115f is coupled to the wrist joint 400h by a U shaped bracket 730. In this example, the U shaped bracket is coupled to the internal frame hand segment 115f and to the wrist joint 400h by rivets. In other examples, other mechanical fasteners may be used. Such a configuration allows the thinner hand segment to move without distorting the thinner internal frame hand segment.

FIG. 7E illustrates a bendable hand segment 700 where the internal frame hand segment 155f is comprised of a “wrist connector” 740. Bendable hand segment also includes pliable wire 750 shaped into fingers and wrapped around the wrist connector 740. FIG. 7E(i) illustrates the “wrist connector” 740 in isolation and FIG. 7E(ii) illustrates the pliable wire 750 in isolation. In this example, the first end of the pliable wire 750(a) is formed into the shape of fingers and the second end of the pliable wire 750(b) is wrapped around the lower part of the hand segment 155f. The wrist connector 740 has an oval opening 740(a) at the top that holds the “fingers” and may be crossed 740(b) in the middle in the area representing the bottom of the hand. In the example shown, the first end of the pliable wire 750(a) is formed into four fingers and one thumb. The four fingers are inserted through the oval opening 740(a) in the wrist connector 740 and the thumb rests below the oval opening 740(a). This configuration is shown in FIG. 7E(iii). The second end of the pliable wire 750(b) is wrapped around the portion of the wrist connector 740 under the oval opening and forms the palmar and dorsal surfaces of the hand. This configuration is shown in FIG. 7E. In the examples shown, the wire of the wrist connector 740 is thicker than the wire of the pliable wire, facilitating the bending of the fingers while maintaining the shape of the hand. FIG. 7E(iv) illustrates this configuration with bent fingers. In other examples (not shown), the wire of the wrist connector 740 may be thinner than the wire of the pliable wire 750 or the wire of the wrist connector 740 and the pliable wire 750 may be the same thickness.

We claim:

1. A three-way joint comprising:
a first hinge, a second hinge, a third hinge, a fourth hinge, and a fifth hinge,
wherein said first hinge is located across from said second hinge;
wherein said third hinge is located across from said fourth hinge; and
wherein said fifth hinge is located adjacent to said first hinge, said second hinge, said third hinge and said fourth hinge.

2. The joint of claim 1, wherein said joint further comprises a bracket, and wherein said first hinge, said second hinge, said third hinge, and said fourth hinge are coupled to said square bracket.

3. The joint of claim 2, wherein said bracket is a square bracket.

4. The joint of claim 3, wherein said first hinge, said second hinge, said third hinge, and said fourth hinge are coupled to said square bracket by rivets.

5. The joint of claim 4, wherein said joint further comprise a horseshoe bracket, and wherein said first hinge, said second hinge, and said fifth hinge are coupled to said horseshoe bracket.

6. The joint of claim 5, wherein said horseshoe bracket couples said joint to an internal frame.

7. The joint of claim 5, wherein said first hinge, said second hinge, and said fifth hinge are coupled to said horseshoe bracket by rivets.

8. The joint of claim 6, wherein said internal frame is wrapped around said rivets of said third hinge, said fourth hinge, and said fifth hinge.

9. The joint of claim 8, wherein said joints further comprise spacers located adjacent to said rivets.

10. The joint of claim 9, wherein said spacers are selected from the group consisting of ring shaped spacers, conical shaped spacers, and wave shaped spacers.

11. The joint of claim 10, wherein said spacers are comprised of spring metal.

12. The joint of claim 10, wherein said spacers are comprised of acetate.

13. The joint of claim 1, wherein said joint is capable of moving along an X axis, along a Y axis, and along a Z axis.

14. The joint of claim 13, wherein said joint is capable of moving in two directions along said X axis, in two directions along said Y axis, and in two directions along said Z axis.

15. The joint of claim 14, wherein said X axis, said Y axis, and said Z axis are mutually orthogonal.

16. The joint of claim 15, wherein said joint is capable of moving 360 degrees around said Z axis.

17. A model comprising:
an internal frame including internal frame body segments representing the structure of human body parts; and,
at least one three-way joint that couples said internal frame body segments and allows movement thereof along three axes.

18. The model of claim 17, further comprising at least one two-way joint that couples said internal frame body segments and allows movement thereof along two axes.

19. The model of claim 17, further comprising an external frame comprising wire, wherein said wire is disposed around said internal frame.

20. The model of claim 17, wherein said at least one three-way joint comprises:
a first hinge, a second hinge, a third hinge, a fourth hinge, and a fifth hinge,
wherein said first hinge is located across from said second hinge;
wherein said third hinge is located across from said fourth hinge; and
wherein said fifth hinge is located adjacent to said first hinge, said second hinge, said third hinge and said fourth hinge.

21. The model of claim 20, wherein said at least one three-way joint further comprises a bracket, and wherein said first hinge, said second hinge, said third hinge, and said fourth hinge are coupled to said square bracket.

22. The model of claim 21, wherein said bracket is a square bracket.

23. The model of claim 22, wherein said first hinge, said second hinge, said third hinge, and said fourth hinge are coupled to said square bracket by rivets.

24. The model of claim 23, wherein said at least one three-way joint further comprise a horseshoe bracket, and wherein said first hinge, said second hinge, and said fifth hinge are coupled to said horseshoe bracket.

25. The model of claim 24, wherein said horseshoe bracket couples said joint to said internal frame.

26. The model of claim 24, wherein said first hinge, said second hinge and said fifth hinge are coupled to said horseshoe bracket by rivets.

27. The model of claim 25, wherein said internal frame is wrapped around said rivets of said third hinge, said fourth hinge, and said fifth hinge.

28. The model of claim 27, wherein said at least one three-way joint further comprises spacers located adjacent to said rivets.

29. The model of claim 28, where said spacers are selected from the group consisting of ring shaped spacers, conical shaped spacers, and wave shaped spacers.

30. The model of claim 29, wherein said spacers are comprised of spring metal.

31. The model of claim 29, wherein said spacers are comprised of acetate

32. The model of claim 20, wherein said at least one three-way joint is capable of moving along an X axis, along a Y axis, and along a Z axis.

33. The model of claim 32, wherein said at least one three-way joint is capable of moving in two directions along said X axis, in two directions along said Y axis, and in two directions along said Z axis.

34. The model of claim 33, wherein said X axis, said Y axis, and said Z axis are mutually orthogonal.

35. The model of claim 33, wherein said at least one three-way joint is capable of moving 360 degrees around said Z axis.

36. A model comprising:
an internal frame including internal frame body segments representing the structure of human body parts;
an external frame, comprising wire, wherein said wire is disposed around said internal frame, and
joints that couple said internal frame body segments and allow movement of thereof along three axes.

37. The model of claim 36, further comprising joints that couple said internal frame body segments and allow movement of thereof along two axes.

38. A two-way joint comprising:
a first hinge, a second hinge, a third hinge, a fourth hinge, and a metal form,
wherein said first hinge, said second hinge, said third hinge, and said fourth hinge are arranged around said metal form and wherein said first hinge is located across from said second hinge, and wherein said third hinge is located across from said fourth hinge.

39. The two-way joint of claim 38, wherein said two-way joint is capable of moving along an X axis and a Y axis.

40. A model comprising:
an internal frame including internal frame body segments representing the structure of human body parts; and
at least one two-way joint that couples said internal frame body segments and allows movement thereof along two axes wherein said at least one two-way joint comprises:
a first hinge, a second hinge, a third hinge, a fourth hinge, and a metal form,
wherein said first hinge, said second hinge, said third hinge, and said fourth hinge are arranged around said metal form and wherein said first hinge is located across from said second hinge, and wherein said third hinge is located across from said fourth hinge.

41. A model hand segment comprising pliable wire and a wrist connector, wherein a first end of said pliable wire is bent into the shape of fingers, and wherein said fingers are inserted through an opening in said wrist connector, and wherein a second end of said pliable wire is wrapped around said wrist connector, creating the impression of palmar and dorsal hand surfaces.
